(19) United States
(12) Patent Application Publication
(10) Pub. No.: US 2026/0297331 A1
(43) Pub. Date: Oct. 1, 2026

(54) CONDUCTIVE CARBON BLACK, POSITIVE ELECTRODE PLATE, ELECTROCHEMICAL APPARATUS, AND ELECTRONIC APPARATUS

(71) Applicant: Ningde Amperex Technology Limited, Ningde (CN)

(72) Inventors: Xiaoqian LIU, Ningde (CN); Dongdong HAN, Ningde (CN)

(73) Assignee: Ningde Amperex Technology Limited, Ningde (CN)

(21) Appl. No.: 19/575,941

(22) Filed: Mar. 24, 2026

(30) Foreign Application Priority Data
Mar. 27, 2025 (CN) 202510371843.0

(51) Int. Cl. C09C 1/48; H01M 4/02; H01M 4/62; H01M 10/0525; H01M 10/0567

(52) U.S. Cl. CPC C09C 1/48; H01M 4/625; H01M 10/0525; H01M 10/0567; C01P 2002/72; C01P 2002/82; C01P 2004/51; C01P 2004/64; C01P 2006/12; C01P 2006/40; C01P 2006/80; H01M 2004/021; H01M 2004/028

(57) ABSTRACT

A conductive carbon black includes a plurality of carbon black units and pores located between adjacent carbon black units. Based on a total mass of the conductive carbon black, a mass percentage of a volatile component in the conductive carbon black is M %. A specific surface area of the conductive carbon black is N m²/g. The conductive carbon black satisfies. 0.003≤M/N≤0.02.

### CROSS-REFERENCE TO RELATED APPLICATION

The present application claims priority to Chinese Patent Application No. 202510371843.0, filed on Mar. 27, 2025, the disclosure of which is hereby incorporated by reference in its entirety.

### TECHNICAL FIELD

This application relates to the field of electrochemical apparatuses, and in particular, to a conductive carbon black, a positive electrode plate, an electrochemical apparatus, and an electronic apparatus.

### BACKGROUND

With the booming development of electronic devices and new energy vehicle industries, the performance of lithium batteries is facing extremely stringent requirements. However, in actual operating conditions, lithium batteries exhibit many drawbacks under different environments and operating states, such as energy waste during charging and discharging, and voltage drop caused by internal resistance in scenarios requiring instantaneous high current output, such as electric vehicle starting, which seriously affects power output performance and reduces the operation stability of the devices.

Therefore, how to effectively solve the problem of low energy conversion efficiency in lithium batteries has become the key to improving the overall performance of lithium batteries.

### SUMMARY

This application provides a conductive carbon black, a positive electrode plate, an electrochemical apparatus, and an electronic apparatus. The conductive carbon black can construct an efficient conductive network in the positive electrode plate and reduce the resistance of the positive electrode plate, thereby improving the energy conversion efficiency of the electrochemical apparatus.

According to a first aspect, this application provides a conductive carbon black, where the conductive carbon black includes a plurality of carbon black units and pores located between adjacent carbon black units; and based on a total mass of the conductive carbon black, a mass percentage of a volatile component in the conductive carbon black is M %, a specific surface area of the conductive carbon black is N m²/g, and the conductive carbon black satisfies: 0.003≤M/N≤0.02.

According to this application, when the conductive carbon black of this application is used and the conductive carbon black satisfies 0.003≤M/N≤0.02, the conductive carbon black can construct an efficient conductive network in a positive electrode plate. On the one hand, direct-current internal resistance of the electrochemical apparatus can be reduced, making electron transport smoother, reducing energy loss during charging and discharging, and improving the energy conversion efficiency of an electrochemical apparatus. On the other hand, the interaction between the conductive carbon black and an electrode material can be enhanced, the structural stability of the electrode material can be improved, structural changes caused by high temperatures can be reduced, and good contact between the electrode material and an electrolyte can be maintained, thereby suppressing cell thickness swelling, reducing a cell thickness swelling rate, and improving the stability and safety of the electrochemical apparatus in high-temperature environments.

In some specific embodiments, the conductive carbon black satisfies: 0.005≤M/N≤0.01.

In the above embodiments, when the conductive carbon black satisfies 0.005≤M/N≤0.01, energy loss during charging and discharging can be further reduced, the energy conversion efficiency of the electrochemical apparatus can be improved, the structural stability of the electrode material can be further improved, the cell thickness swelling rate can be reduced, and the stability and safety of the electrochemical apparatus in high-temperature environments can be improved.

In some specific embodiments, based on the total mass of the conductive carbon black, the mass percentage of the volatile component in the conductive carbon black is 0.1% to 0.7%, and/or the specific surface area of the conductive carbon black is 30 m²/g to 80 m²/g.

In the above specific embodiments, when the mass percentage of the volatile component in the conductive carbon black is 0.1% to 0.7%, a binder can be better combined with a conductive agent, and the volatile component can make the conductive agent more uniformly distributed and can provide a certain “coating effect” on the electrode material together with the binder, reducing direct contact between the positive electrode material and the electrolyte, reducing side reactions, reducing a cell thickness swelling rate at high temperatures, and improving the stability and safety of the electrochemical apparatus in high-temperature environments. When the specific surface area of the conductive carbon black is too small, an effective conductive area is reduced, thereby increasing the direct-current internal resistance of the electrochemical apparatus, and resulting in a deteriorated dispersion effect of the conductive carbon black and reduced coating of a positive electrode active material, thus increasing the cell thickness swelling rate.

In some specific embodiments, based on the total mass of the conductive carbon black, the mass percentage of the volatile component in the conductive carbon black is 0.3% to 0.6%, and/or the specific surface area of the conductive carbon black is 50 m²/g to 70 m²/g.

In the above specific embodiments, when the mass percentage of the volatile component in the conductive carbon black is 0.3% to 0.6%, and/or the specific surface area of the conductive carbon black is 50 m²/g to 70 m²/g, on the one hand, electron transport in the positive electrode material is further promoted, and on the other hand, the direct-current internal resistance of the electrochemical apparatus is further reduced, allowing electrons to flow more efficiently from an external circuit into the positive electrode active material to participate in the electrochemical reaction or flow out of the positive electrode active material to the external circuit, reducing energy loss, thereby significantly improving the energy conversion efficiency of the electrochemical apparatus. In addition, an interface between the electrode material and the electrolyte is stabilized, excessive cell thickness swelling is further suppressed, the cell thickness swelling rate is effectively reduced, and the stability and safety of the electrochemical apparatus in high-temperature environments are further improved. More preferably, the specific surface area of the conductive carbon black is 50 m²/g to 60 m²/g, the energy conversion efficiency of the electrochemical apparatus can be better improved, and the interface between the electrode material and the electrolyte can be better stabilized, suppressing excessive cell thickness swelling, effectively reducing the cell thickness swelling rate, and better improving the stability and safety of the electrochemical apparatus in high-temperature environments.

In some specific embodiments, based on the total mass of the conductive carbon black, the conductive carbon black includes A % of oxygen element, the conductive carbon black includes B % of hydrogen element, and the conductive carbon black satisfies: 0.5≤A/B≤2.

In the above specific embodiments, when the conductive carbon black satisfies 0.5≤A/B≤2, the chemical properties of the surface of the conductive carbon black can be optimized. Oxygen-containing functional groups and hydrogen-containing structures on the surface of the conductive carbon black are adjusted. Their synergistic effect optimizes the conductive network constructed by the conductive carbon black, improves electron transport efficiency, reduces the direct-current internal resistance of the electrochemical apparatus, and reduces energy loss during charging and discharging, thereby improving the energy conversion efficiency of the electrochemical apparatus. In addition, the stabilizing effect of the conductive carbon black on the electrode material structure can be enhanced. Their synergistic effect can reduce structural changes of the electrode material caused by high temperatures, and maintain good contact between the electrode material and the electrolyte. In addition, the binder can be better combined with the conductive agent, and the volatile component can make the conductive agent more uniformly distributed and can provide a certain “coating effect” on the electrode material together with the binder, reducing direct contact between the positive electrode material and the electrolyte, reducing side reactions, and reducing the cell thickness swelling rate. The binder can be better combined with the conductive agent, and the volatile component can make the conductive agent more uniformly distributed and can provide a certain “coating effect” on the electrode material together with the binder, reducing the direct contact between the positive electrode material and the electrolyte, reducing side reactions, and reducing the cell thickness swelling rate at high temperatures, thereby reducing the cell thickness swelling rate and improving the stability and safety of the electrochemical apparatus in high-temperature environments. When A/B is too large, oxygen element and hydrogen element are applied on the surface of the conductive carbon black, resulting in weakened conductivity of the conductive carbon black and increased resistivity of the conductive agent.

In some specific embodiments, the conductive carbon black satisfies: 0.8≤A/B≤1.5.

In the above specific embodiments, when the conductive carbon black satisfies 0.8≤A/B≤1.5, their synergistic effect further optimizes the conductive network constructed by the conductive carbon black, further improves electron transport efficiency, reduces the direct-current internal resistance of the electrochemical apparatus, and reduces energy loss during charging and discharging, thereby further improving the energy conversion efficiency of the electrochemical apparatus. In addition, structural changes of the electrode material caused by high temperatures are further reduced, good contact between the electrode material and the electrolyte is maintained, cell thickness swelling is further suppressed, the cell thickness swelling rate is reduced, and the stability and safety of the electrochemical apparatus in high-temperature environments are further improved.

In some specific embodiments, based on the total mass of the conductive carbon black, the conductive carbon black includes 0.05% to 0.3% of oxygen element, and/or the conductive carbon black includes 0.05% to 0.3% of hydrogen element.

In the above specific embodiments, when the conductive carbon black includes 0.05% to 0.3% of oxygen element, and/or the conductive carbon black includes 0.05% to 0.3% of hydrogen element, the oxygen-containing functional groups can enhance the chemical adsorption between the conductive carbon black and the positive electrode active material, promoting the transfer of electrons from the conductive carbon black to the active material. The hydrogen-containing structure adjusts the electron cloud distribution of the conductive carbon black to a certain extent, improving the intrinsic conductivity of the conductive carbon black, thereby improving the energy conversion efficiency of the electrochemical apparatus. In addition, oxygen element can participate in forming stable chemical bonds, helping to maintain the lattice structure of the electrode material and resist lattice distortion caused by high temperatures. Hydrogen element can assist in adjusting the microenvironment around the electrode material through weak interactions such as hydrogen bonds, alleviating stress concentration caused by high temperatures, and improving the stability and safety of the electrochemical apparatus in high-temperature environments. Moreover, the presence of hydrogen element and oxygen element indicates that the carbon black surface contains polar functional groups. On the one hand, this can increase the repulsion between carbon black particles; and on the other hand, this can increase the binding between binder molecules and carbon black, improving the dispersion uniformity of carbon black, thereby optimizing the continuity of the conductive network formed by the conductive carbon black in the electrode plate, and improving electron transfer efficiency. In addition, the binder can be better combined with the conductive agent, and the presence of the volatile component can make the conductive agent more uniformly distributed, providing a better “coating effect” on the positive electrode material, and reducing contact between the positive electrode active material and the electrolyte, thereby reducing side reactions and alleviating the cell swelling at high temperatures.

In some specific embodiments, based on the total mass of the conductive carbon black, the conductive carbon black includes 0.08% to 0.15% of oxygen element, and/or the conductive carbon black includes 0.08% to 0.15% of hydrogen element.

In the above specific embodiments, when the conductive carbon black includes 0.08% to 0.15% of oxygen element, and/or the conductive carbon black includes 0.08% to 0.15% of hydrogen element, the energy conversion efficiency of the electrochemical apparatus and the stability and safety of the electrochemical apparatus in high-temperature environments can be further improved.

In some specific embodiments, the conductive carbon black satisfies at least one of the following: (1) based on the total mass of the conductive carbon black, the conductive carbon black includes 100 ppb to 500 ppb of magnetic impurities; (2) based on the total mass of the conductive carbon black, the conductive carbon black includes 50 ppb to 500 ppb of ash; (3) a loss temperature of the volatile component in the conductive carbon black is 550° C. to 950° C.; (4) Dᵥ50 of the conductive carbon black is 1000 nm to 6000 nm; (5) an average particle size of the carbon black units is 30 nm to 70 nm; (6) a powder resistivity of the conductive carbon black is 25 mΩ·cm to 45 mΩ·cm; (7) a full width at half maximum of a (002) crystal plane diffraction peak in an X-ray diffraction pattern of the conductive carbon black is 1° to 5°; (8) a ratio of a peak value at 1700-1730 cm⁻¹ to a peak value at 2500-3000 cm⁻¹ in an infrared absorption spectrum of the conductive carbon black is 0.2 to 0.7; (9) the conductive carbon black includes a core formed by stacking the plurality of carbon black units and a plurality of branches connected to the core; or (10) Dᵥ50 of the conductive carbon black is C nm, an average particle size of the carbon black units is D nm, and the conductive carbon black satisfies: 25≤C/D≤150.

In the above specific embodiments, when the conductive carbon black includes 100 ppb to 500 ppb of magnetic impurities, an internal structure of the electrochemical apparatus can be kept stable, and capacity loss caused by problems such as short circuits can be reduced. In addition, since the reduction potential of metal impurity ions is lower than that of lithium ions, during charging, metal impurity ions are first intercalated into a carbon negative electrode to occupy intercalation positions for lithium ions, reducing the reversible capacity of a lithium-ion electrochemical apparatus. During high-temperature cycling, this effect is gradually accumulated, leading to rapid capacity decay of the electrochemical apparatus. When the conductive carbon black includes 100 ppb to 500 ppb of magnetic impurities, lithium ions can be more fully intercalated and deintercalated during charging and discharging, reducing irreversible capacity loss, thereby increasing a high-temperature cycling retention rate of the electrochemical apparatus. When the magnetic impurities are excessive, side reactions occur during cycling of the electrochemical apparatus, reducing the cycling capacity retention rate.

When the conductive carbon black includes 50 ppb to 500 ppb of ash, the conductive carbon black particles may be in better contact with each other, forming a more effective conductive network, and allowing smoother electron transport during charging and discharging of the electrochemical apparatus. During high-temperature cycling, the internal chemical reactions of the electrochemical apparatus are intense, and good conductivity helps to maintain stable performance of the electrochemical apparatus, reducing energy loss and heat generation of the electrochemical apparatus caused by increased resistance, and reducing the probability of side reactions. In high-temperature environments, the impact of side reactions is more significant, and reducing side reactions helps to maintain the stability of an internal chemical system of the electrochemical apparatus, allowing the electrochemical apparatus to maintain higher capacity after multiple cycles, thereby increasing the high-temperature cycling retention rate. When the content of ash is excessive, side reactions occur during cycling of the electrochemical apparatus, reducing the cycling capacity retention rate.

When the loss temperature of the volatile component in the conductive carbon black is 550° C. to 950° C., the conductive carbon black does not undergo significant changes in structure and performance due to large loss of the volatile component, thereby maintaining its own morphology and conductivity, maintaining a good conductive network inside the electrochemical apparatus, and ensuring smooth electron transport. Moreover, the volatile component is relatively stable within an operating temperature range of the electrochemical apparatus and is not prone to decomposition or participation in other side reactions, thereby helping to increase the high-temperature cycling retention rate of the electrochemical apparatus. When the loss temperature of the volatile component is too high, carbon chains where functional groups are located are longer, and excessively long carbon chains lead to reduced proportion and uneven attachment of the functional groups, thus making the dispersion of the conductive carbon black poor and prone to agglomeration. When the loss temperature of the volatile component is too low, the carbon chains where the functional groups are located are shorter and prone to decomposition reactions, thus affecting the performance of the electrochemical apparatus. When Dᵥ50 of the conductive carbon black is 1000 nm to 6000 nm, the conductive carbon black can form a relatively continuous conductive path in the electrode, allowing for shorter paths and lower resistance for electron transport. When the electrochemical apparatus is discharged at high rates, the demand for rapid conduction of a large number of electrons can be met, thereby improving the discharge rate performance of the electrochemical apparatus and allowing the electrochemical apparatus to release more electricity in a short time. In addition, when the electrode material expands, the conductive carbon black particles can be squeezed and deformed to a certain extent, absorbing part of the thermal stress, thereby alleviating the overall swelling of the electrode and reducing the cell thickness swelling rate.

When the average particle size of the carbon black units is 30 nm to 70 nm, the conductive carbon black can be in full contact with the electrode material, providing more conductive sites. This helps to form a dense conductive network inside the electrode, making electron transport paths more abundant, thereby reducing the internal resistance of the electrochemical apparatus. During high-rate discharge, electrons can be transported more quickly between the electrode material and the conductive carbon black, improving the discharge efficiency of the electrochemical apparatus, thereby improving the discharge rate performance. In addition, tiny pores and grain boundaries of the electrode material can be filled with fine carbon black particles. During high-temperature storage, these fine carbon black particles can provide a certain supporting effect, limiting the thermal expansion and lattice changes of the electrode material particles, thereby suppressing the overall swelling of the electrode and reducing the cell thickness swelling rate. When the average particle size of the carbon black units is too small, the binder is consumed, thus increasing the cell swelling rate at high temperatures. In addition, an excessively small average particle size of the carbon black units is also prone to uneven dispersion, reducing the rate performance of the electrochemical apparatus.

When the powder resistivity of the conductive carbon black is 25 mΩ·cm to 45 mΩ·cm, the overall resistance of the electrode can be effectively reduced, allowing for rapid electron transport in the electrode material and increasing the rate of electrochemical reactions during charging and discharging. Moreover, this helps to form a uniform electric field distribution inside the electrochemical apparatus, making the electrochemical reactions on the electrode surface more uniform and avoiding reaction imbalance in local regions due to excessively high or low electric field strength. During high-temperature cycling, the uniform reactions help to reduce local loss and polarization of the electrode material, prolonging the service life of the electrochemical apparatus, and increasing the high-temperature cycling retention rate of the electrochemical apparatus.

When the full width at half maximum of the (002) crystal plane diffraction peak in the X-ray diffraction pattern of the conductive carbon black is 10 to 5°, the surface of the conductive carbon black has more active sites. During charging and discharging of the electrochemical apparatus, these active sites can promote the electrochemical reactions between the electrode material and the electrolyte, increasing the reaction rate. Under high-temperature cycling conditions, an internal chemical reaction rate of the electrochemical apparatus accelerates, and more active sites help to maintain higher reaction efficiency, allowing the electrochemical apparatus to perform charging and discharging more fully. In addition, the conductive carbon black is better combined with the electrode material, enhancing interface adhesion. During high-temperature cycling of the electrochemical apparatus, volume expansion and contraction of the electrode material occur due to charging and discharging, and good bonding can effectively buffer the stress caused by such volume changes, reduce shedding and pulverization of the electrode material, and maintain the integrity of the electrode structure, thereby increasing the high-temperature cycling retention rate of the electrochemical apparatus. When the full width at half maximum of the diffraction peak is too large, side reactions occur during cycling of the electrochemical apparatus, reducing the cycling capacity retention rate. When the full width at half maximum of the diffraction peak is too small, the binding ability between the conductive carbon black and the binder is weak, making the conductive carbon black difficult to disperse and prone to agglomeration, thereby reducing the coating of the conductive carbon black on the positive electrode active material and reducing the cycling capacity retention rate.

When the ratio of the peak value at 1700-1730 cm⁻¹ to the peak value at 2500-3000 cm⁻¹ in the infrared absorption spectrum of the conductive carbon black is 0.2 to 0.7, the conductive carbon black can interact with the electrode material through hydrogen bonding and other effects, improving the electron transport efficiency between the conductive carbon black and the electrode material. In addition, this helps to form good conductive channels and ion transport paths on the electrode surface, reducing obstacles to electron and ion transport, reducing the internal resistance of the electrochemical apparatus, and reducing energy loss inside the electrochemical apparatus, thereby improving the energy conversion efficiency of the electrochemical apparatus. Moreover, this helps to improve the interface compatibility between the electrode and the electrolyte. Hydroxyl and other functional groups can interact with some components in the electrolyte, consuming substances that may cause side reactions, inhibiting decomposition of the electrolyte at high temperatures and side reactions on the electrode surface, and reducing gas and heat generation, thereby lowering the internal pressure of the electrochemical apparatus and suppressing cell thickness swelling.

When the conductive carbon black includes the core formed by stacking the plurality of carbon black units and the plurality of branches connected to the core, the core formed by stacking the plurality of carbon black units provides a main channel for electron transport, reducing the resistance to electron transport. The branches connected to the core increase contact points and contact area between the conductive carbon black and the electrode material, allowing electrons to be transported to various parts of the electrode material more quickly and efficiently through the branches. In addition, the carbon black units are combined with each other to form a multi-branched structure with intermolecular bonding. The presence of the branched structure is conducive to a continuous conductive network, improving electron transport efficiency and reducing electron transport resistance, thereby forming a more complete and efficient conductive network inside the electrochemical apparatus. During high-temperature cycling, the internal chemical reaction rate of the electrochemical apparatus accelerates, and the requirement for electron transport efficiency is higher. This structure can ensure rapid conduction of electrons and maintain the charging and discharging performance of the electrochemical apparatus, thereby increasing the high-temperature cycling retention rate.

When the conductive carbon black satisfies 25≤C/D≤150, a multi-level structure with both large particles for support and fine particles for tight filling can be formed. This structure is conducive to constructing a stable and efficient conductive network inside the electrode. Their synergistic effect can increase an electrolyte retention rate of the electrode plate, promote the transport, adsorption, and desorption of lithium ions, thereby reducing the internal resistance of the electrochemical apparatus and increasing the discharge rate. Moreover, agglomeration and deformation of the electrode material at high temperatures can be reduced, and local overheating and intensification of side reactions can be suppressed, thereby lowering the internal pressure of the electrochemical apparatus and suppressing cell thickness swelling. When C/D is too large, the interaction between conductive carbon black particles is strong, making dispersion difficult, thus causing uneven dispersion of the conductive carbon black and affecting the performance of the electrochemical apparatus.

In some specific embodiments, the conductive carbon black satisfies at least one of the following: (1) Dᵥ50 of the conductive carbon black is 1500 nm to 5000 nm; (2) the average particle size of the carbon black units is 40 nm to 60 nm; (3) the powder resistivity of the conductive carbon black is 30 mΩ·cm to 40 mΩ·cm; (4) the full width at half maximum of the (002) crystal plane diffraction peak in the X-ray diffraction pattern of the conductive carbon black is 1.5° to 30; or (5) the ratio of the peak value at 1700-1730 cm⁻¹ to the peak value at 2500-3000 cm⁻¹ in the infrared absorption spectrum of the conductive carbon black is 0.3 to 0.6.

In the above specific embodiments, when the conductive carbon black satisfies any one of the above conditions, the electron transport efficiency between the conductive carbon black and the electrode material can be further improved, and the internal resistance of the positive electrode plate can be reduced, thereby further improving the cycling retention rate and energy conversion efficiency of the electrochemical apparatus. According to a second aspect, this application provides a positive electrode plate, where the positive electrode plate includes a binder, positive electrode active material particles, and a conductive agent; and the conductive agent includes the conductive carbon black according to the first aspect and carbon nanotubes. The positive electrode plate has good lithium ion transport and structural stability, thereby improving the performance of an electrochemical apparatus.

In some specific embodiments, the positive electrode plate satisfies at least one of the following: (1) a specific surface area of the conductive agent is E m²/g, based on a total mass of the positive electrode plate, the positive electrode plate includes W₁% of the conductive agent and W₂% of the binder, and the positive electrode plate satisfies: 0.004×E×W₁≤W₂≤0.014×E×W₁; (2) a specific surface area of the conductive agent is 40 m²/g to 300 m²/g; (3) based on a total mass of the positive electrode plate, the positive electrode plate includes 0.5% to 3% of the conductive agent; (4) based on a total mass of the positive electrode plate, the positive electrode plate includes 0.5% to 5% of the binder; or (5) a mass ratio of the conductive carbon black to the carbon nanotubes in the conductive agent is 0.6 to 2.

In the above specific embodiments, when the positive electrode plate satisfies 0.004×E×W₁≤W₂≤0.014×E×W₁, the binder can better bond the conductive agent and an active material together, allowing the conductive agent to be uniformly dispersed in the active material, and forming an efficient conductive network. In addition, an appropriate amount of binder does not excessively block electrode pores, ensuring electrolyte penetration and lithium ion transport channels, thereby reducing the internal resistance of the electrochemical apparatus and increasing the discharge rate. Moreover, the interface compatibility between an electrode and an electrolyte can be improved, reducing decomposition of the electrolyte at high temperatures and side reactions on an electrode surface. Good interface compatibility helps to reduce reaction resistance on the electrode surface, making the reaction more uniform, and reducing local overheating and gas generation. Reduced gas generation can lower the internal pressure of the electrochemical apparatus, thereby suppressing cell thickness swelling.

When the specific surface area of the conductive agent is 40 m²/g to 300 m²/g, the conductive agent has more abundant pore structures and greater surface energy. The pore structures are conducive to adsorption and storage of the electrolyte, providing more transport channels for lithium ions, and accelerating the diffusion rate of lithium ions in the electrode material. The time for lithium ions to migrate from the interior to the surface of the active material is shortened, thereby improving the lithium ion supply rate during high-rate discharge of the electrochemical apparatus and increasing the discharge rate. In addition, better support can be provided between active material particles, improving the stability of the electrode structure. In high-temperature environments, the active material may undergo thermal expansion and structural changes, and the conductive agent with a large specific surface area and good dispersion can restrict excessive movement and agglomeration of the active material particles, maintaining the integrity of the electrode structure, thereby reducing the cell thickness swelling rate.

When the positive electrode plate includes 0.5% to 3% of the conductive agent and/or 0.5% to 5% of the binder, the electrode porosity can be increased, which is conducive to electrolyte penetration and lithium ion diffusion. The conductive agent and the binder are synergized with the conductive network, so that the lithium ion migration rate is increased, thereby increasing the discharge rate of the electrochemical apparatus. In addition, the conductive agent and the binder can improve the interface performance between the electrode and the electrolyte. The binder prevents excessive contact between the electrolyte and the active material, suppressing side reactions. The conductive agent promotes charge transfer on the electrode surface, making the reaction more uniform and reducing local overheating and gas generation. Their combined effect lowers the internal pressure of the electrochemical apparatus, thereby suppressing cell thickness swelling.

When the mass ratio of the conductive carbon black to the carbon nanotubes in the conductive agent is 0.6 to 2, their synergistic effect helps to optimize the pore structure and surface properties inside the electrode. The porous structure of the conductive carbon black can adsorb more electrolyte, providing abundant transport channels and storage sites for lithium ions. The presence of carbon nanotubes can further guide the transport direction of lithium ions, allowing lithium ions to be diffused more quickly and uniformly in the electrode material. Therefore, during charging and discharging, lithium ions can be more efficiently intercalated and deintercalated between the active material and the electrolyte, thereby increasing the discharge rate of the electrochemical apparatus. Moreover, in high-temperature environments, the synergistic effect of the conductive carbon black and the carbon nanotubes can improve the stability of the electrode structure. The conductive carbon black can be filled between active material particles, providing buffer and support, reducing mutual squeezing and deformation of the active material particles due to thermal expansion. The carbon nanotubes can interpenetrate the entire electrode structure like a “skeleton”, improving the overall mechanical strength of the electrode and restricting displacement and agglomeration of the active material particles. Their synergistic effect can form a stable three-dimensional structure, effectively suppressing swelling and deformation of the electrode at high temperatures, thereby reducing the cell thickness swelling rate.

In some specific embodiments, the positive electrode plate satisfies at least one of the following: (1) the positive electrode plate satisfies: 0.007×E×W₁≤W₂≤0.012×E×W₁; (2) the specific surface area of the conductive agent is 100 m²/g to 200 m²/g; (3) based on the total mass of the positive electrode plate, the positive electrode plate includes 0.8% to 2.5% of the conductive agent; (4) based on the total mass of the positive electrode plate, the positive electrode plate includes 1.0% to 3.0% of the binder; or (5) the mass ratio of the conductive carbon black to the carbon nanotubes in the conductive agent is 0.8 to 1.5.

In the above specific embodiments, when the positive electrode plate satisfies at least one of the above conditions, the discharge rate of the electrochemical apparatus can be increased, and the cell thickness swelling rate can be reduced.

According to a third aspect, this application provides an electrochemical apparatus, where the electrochemical apparatus includes the positive electrode plate according to the second aspect, a negative electrode plate, a separator, and an electrolyte. The electrochemical apparatus has low internal resistance and low cell thickness swelling rate during high-temperature storage as well as high high-temperature cycling capacity retention rate and charging and discharging performance.

In some specific embodiments, the electrochemical apparatus satisfies at least one of the following: (1) based on a total mass of the electrolyte, the electrolyte includes Z % of a dinitrile additive, a specific surface area of the conductive agent is E m²/g, and the electrochemical apparatus satisfies: 50≤E/Z≤1000; (2) based on a total mass of the electrolyte, the electrolyte includes 0.5% to 5% of 2,2-difluoroethyl acetate; (3) Dᵥ50 of the positive electrode active material particles is G m, based on a total mass of the electrolyte, the electrolyte includes X % of propyl propionate, and the electrochemical apparatus satisfies: 2≤G/X≤5; (4) Dᵥ50 of the positive electrode active material particles is 5 μm to 25 μm; or (5) based on a total mass of the electrolyte, the electrolyte includes 5% to 30% of propyl propionate.

In the above specific embodiments, when the electrochemical apparatus satisfies 14.2≤E/Z≤7500, the dinitrile additive can form a stable solid electrolyte interface (SEI) film on an electrode surface. The film can prevent further reaction between the electrolyte and an electrode material and reduce corrosion and dissolution of the electrode material, thereby improving the cycling stability of the electrochemical apparatus. A high specific surface area of the conductive carbon black helps to uniformly distribute the active material on the electrode surface, reduce agglomeration and shedding of the active material, and also facilitate uniform formation of the SEI film, ensuring the synergistic effect of the additive and the conductive carbon black in improving cycling stability, and allowing the electrochemical apparatus to still maintain good performance after multiple charge-discharge cycles. In addition, their synergistic effect makes charge transport inside the electrochemical apparatus more efficient and the charging and discharging process smoother.

The electrolyte including 0.02% to 12.5% of 2,2-difluoroethyl acetate helps to maintain the fluidity of the electrolyte in low-temperature environments, allowing smoother ion transport inside the electrochemical apparatus, thereby improving the charging and discharging efficiency and capacity of the electrochemical apparatus at low temperatures, and reducing performance degradation of the electrochemical apparatus at low temperatures. In addition, the additive can form a stable solid electrolyte interface (SEI) film on the electrode surface. This film can prevent side reactions between the electrolyte and the electrode material, reduce corrosion and dissolution of the electrode material, and suppress loss of active material, thereby prolonging the cycle life of the electrochemical apparatus, and allowing the electrochemical apparatus to still maintain good performance after multiple charge-discharge cycles. However, excessive 2,2-difluoroethyl acetate causes reduced electrolyte conductivity, making the CEI film loose, thus reducing the cycling performance and rate performance of the electrochemical apparatus.

The electrochemical apparatus satisfying 0.125≤G/X≤0.83 helps to achieve good matching between the positive electrode active material particles and propyl propionate in the electrolyte. Propyl propionate can better wet the surface of the active material particles, increasing a contact area between the electrode and the electrolyte, facilitating ion transport at an interface, and reducing interface resistance, thereby improving the charging and discharging efficiency of the electrochemical apparatus. When G/X is too small, the Li⁺ content in the electrolyte is diluted, reducing the conductivity of the electrochemical apparatus, and the formed CEI film is loose and excessively thick, thus reducing the cycling performance and rate performance of the electrochemical apparatus.

According to a fourth aspect, this application provides an electronic apparatus, where the electronic apparatus includes the electrochemical apparatus according to the third aspect.

### DETAILED DESCRIPTION

To make the objectives, technical solutions, and advantages of some embodiments of this application clearer, the technical solutions in these embodiments of this application will be clearly described below. Apparently, the described embodiments are only some rather than all of these embodiments of this application. All other embodiments obtained by those of ordinary skill in the art based on these embodiments in this application without creative effort shall fall within the protection scope of this application.

As used in this application, the terms “include”, “contain”, and “comprise” are used in their open and non-limiting sense.

In addition, quantities, ratios, and other numerical values are sometimes presented herein in range format. It should be understood that such range format is used for convenience and brevity and should be interpreted flexibly to include not only the numerical values explicitly specified as the limits of the range, but also all the individual numerical values or sub-ranges encompassed within that range as if each numerical value and sub-range is explicitly specified.

In the detailed description and claims, a list of items joined by the terms “one or more of”, “one or more pieces of”, “at least one of”, or other similar terms may mean any combination of the listed items. For example, if items A and B are listed, then the phrase “at least one of A or B” means only A; only B; or A and B. In another example, if items A, B, and C are listed, then the phrase “at least one of A, B, or C” means only A; only B; only C; A and B (excluding C); A and C (excluding B); B and C (excluding A); or all of A, B, and C. Item A may include a single element or a plurality of elements. Item B may include a single element or a plurality of elements. Item C may include a single element or a plurality of elements.

With the booming development of electronic devices and new energy vehicle industries, the performance of lithium batteries is facing extremely stringent requirements. However, in actual operating conditions, lithium batteries exhibit many drawbacks under different environments and operating states, such as energy waste during charging and discharging, and voltage drop caused by internal resistance in scenarios requiring instantaneous high current output, such as electric vehicle starting, which seriously affects power output performance and reduces the operation stability of the devices.

Therefore, how to effectively solve the problem of low energy conversion efficiency in lithium batteries has become the key to improving the overall performance of lithium batteries.

Based on the above problems, some embodiments of this application provide a conductive carbon black, a positive electrode plate, an electrochemical apparatus, and an electronic apparatus. The conductive carbon black can construct an efficient conductive network in the positive electrode plate and reduce the resistance of the positive electrode plate, thereby improving the energy conversion efficiency of the electrochemical apparatus.

Some embodiments of this application are described in detail below.

### Conductive Carbon Black

Some embodiments of this application provide a conductive carbon black, where the conductive carbon black includes a plurality of carbon black units and pores located between adjacent carbon black units. The carbon black units in this application refer to individual spheres constituting branched carbon black. Based on a total mass of the conductive carbon black, a mass percentage of a volatile component in the conductive carbon black is M %, a specific surface area of the conductive carbon black is N m²/g, and the conductive carbon black satisfies: 0.003≤M/N≤0.02.

For example, M/N may be 0.003, 0.004, 0.005, 0.006, 0.007, 0.008, 0.009, 0.01, 0.011, 0.012, 0.013, 0.014, 0.015, 0.016, 0.017, 0.018, 0.019, 0.02, or a range defined by any of these values.

Optionally, 0.005≤M/N≤0.02, 0.005≤M/N≤0.018, 0.005≤M/N≤0.016, 0.005≤M/N≤0.014, 0.005≤M/N≤0.012, or 0.005≤M/N≤0.01.

According to this application, when the conductive carbon black of this application is used and the conductive carbon black satisfies 0.003≤M/N≤0.02, the conductive carbon black can construct an efficient conductive network in a positive electrode plate. On the one hand, the direct-current internal resistance of the electrochemical apparatus can be reduced, making electron transport smoother, reducing energy loss during charging and discharging, and improving the energy conversion efficiency of an electrochemical apparatus. On the other hand, the interaction between the conductive carbon black and an electrode material can be enhanced, the structural stability of the electrode material can be improved, structural changes caused by high temperatures can be reduced, and good contact between the electrode material and an electrolyte can be maintained, thereby suppressing cell thickness swelling, reducing a cell thickness swelling rate, and improving the stability and safety of the electrochemical apparatus in high-temperature environments.

In some specific embodiments, based on the total mass of the conductive carbon black, the mass percentage of the volatile component in the conductive carbon black is 0.1% to 0.7%, and/or the specific surface area of the conductive carbon black is 30 m²/g to 80 m²/g.

For example, the percentage of the volatile component in the conductive carbon black may be 0.1%, 0.15%, 0.12%, 0.25%, 0.3%, 0.35%, 0.4%, 0.45%, 0.5%, 0.55%, 0.6%, 0.65%, 0.7%, or a range defined by any of these values.

The specific surface area of the conductive carbon black may be 30 m²/g, 35 m²/g, 40 m²/g, 45 m²/g, 50 m²/g, 55 m²/g, 60 m²/g, 65 m²/g, 70 m²/g, 75 m²/g, 80 m²/g, or a range defined by any of these values.

Optionally, the percentage of the volatile component in the conductive carbon black may be 0.15% to 0.7%, 0.2% to 0.7%, 0.25% to 0.7%, 0.3% to 0.7%, 0.3% to 0.65%, or 0.3% to 0.6%.

Optionally, the specific surface area of the conductive carbon black may be 35 m²/g to 80 m²/g, 40 m²/g to 80 m²/g, 45 m²/g to 80 m²/g, 50 m²/g to 80 m²/g, 50 m²/g to 75 m²/g, or 50 m²/g to 70 m²/g.

In the above specific embodiments, when the mass percentage of the volatile component in the conductive carbon black is 0.1% to 0.7%, and/or the specific surface area of the conductive carbon black is 30 m²/g to 80 m²/g, electrons can flow more efficiently from an external circuit into a positive electrode active material to participate in the electrochemical reaction or flow out of the positive electrode active material to the external circuit, reducing energy loss, thereby improving the energy conversion efficiency of the electrochemical apparatus. In addition, the microenvironment around the conductive carbon black and the electrode material can be adjusted, thereby alleviating the impact of high temperatures on the structure of the electrode material and maintaining good contact between the electrode material and the electrolyte. When structural changes occur inside a cell due to high temperatures, the presence of the volatile component helps to stabilize the lattice structure of the electrode material and suppress phenomena such as lattice distortion caused by high temperatures, thereby effectively reducing the cell thickness swelling rate and improving the stability and safety of the electrochemical apparatus in high-temperature environments. When the specific surface area of the conductive carbon black is too small, an effective conductive area is reduced, thereby increasing the direct-current internal resistance of the electrochemical apparatus, and resulting in a deteriorated dispersion effect of the conductive carbon black and reduced coating of the positive electrode active material, thus increasing the cell thickness swelling rate.

In some specific embodiments, based on the total mass of the conductive carbon black, the conductive carbon black includes A % of oxygen element, the conductive carbon black includes B % of hydrogen element, and the conductive carbon black satisfies: 0.5≤A/B≤2.

For example, A/B may be 0.5, 0.6, 0.7, 0.8, 0.9, 1, 1.1, 1.2, 1.3, 1.4, 1.5, 1.6, 1.7, 1.8, 1.9, 2, or a range defined by any of these values.

Optionally, 0.6≤A/B≤2, 0.7≤A/B≤2, 0.8≤A/B≤2, 0.8≤A/B≤1.9, 0.8≤A/B≤1.8, 0.8≤A/B≤1.7, 0.8≤A/B≤1.6, or 0.8≤A/B≤1.5.

In the above specific embodiments, when the conductive carbon black satisfies 0.5≤A/B≤2, the chemical properties of the surface of the conductive carbon black can be optimized. Oxygen-containing functional groups and hydrogen-containing structures on the surface of the conductive carbon black are adjusted. Their synergistic effect optimizes the conductive network constructed by the conductive carbon black, improves electron transport efficiency, reduces the direct-current internal resistance of the electrochemical apparatus, and reduces energy loss during charging and discharging, thereby improving the energy conversion efficiency of the electrochemical apparatus. In addition, the stabilizing effect of the conductive carbon black on the electrode material structure can be enhanced. Their synergistic effect can reduce structural changes of the electrode material caused by high temperatures, maintain good contact between the electrode material and the electrolyte, and effectively suppress cell thickness swelling, thereby reducing the cell thickness swelling rate and improving the stability and safety of the electrochemical apparatus in high-temperature environments. When A/B is too large, oxygen element and hydrogen element are applied on the surface of the conductive carbon black, resulting in weakened conductivity of the conductive carbon black and increased resistivity of a conductive agent.

It should be noted that the percentage of oxygen element and the percentage of hydrogen element of the conductive carbon black can be detected using methods and instruments known in the art. For example, the positive electrode plate can be obtained by disassembling the electrochemical apparatus and then further disassembled to obtain the conductive carbon black. An elemental analyzer method is used, and an appropriate amount of conductive carbon black sample is weighed and placed in a sample boat of an elemental analyzer. Then, the sample boat is sent into a combustion furnace, and the sample undergoes a combustion reaction under the action of a high temperature and an oxygen flow. A product obtained after combustion passes through a series of separation and detection apparatuses. For example, water is absorbed through a drying agent to detect the water generated from the conversion of hydrogen element, and carbon dioxide generated from the conversion of oxygen element is detected through a carbon dioxide absorbent. An instrument automatically calculates and displays the percentages of hydrogen element and oxygen element based on an absorption amount.

In some specific embodiments, based on the total mass of the conductive carbon black, the conductive carbon black includes 0.05% to 0.3% of oxygen element, and/or the conductive carbon black includes 0.05% to 0.3% of hydrogen element.

For example, the percentage of oxygen element in the conductive carbon black may be 0.05%, 0.08%, 0.1%, 0.12%, 0.15%, 0.18%, 0.2%, 0.22%, 0.25%, 0.28%, 0.3%, or a range defined by any of these values.

The percentage of hydrogen element in the conductive carbon black may be 0.05%, 0.08%, 0.1%, 0.12%, 0.15%, 0.18%, 0.2%, 0.22%, 0.25%, 0.28%, 0.3%, or a range defined by any of these values.

Optionally, the percentage of oxygen element in the conductive carbon black may be 0.08% to 0.3%, 0.08% to 0.28%, 0.08% to 0.25%, 0.08% to 0.22%, 0.08% to 0.2%, 0.08% to 0.18%, or 0.08% to 0.15%.

Optionally, the percentage of hydrogen element in the conductive carbon black may be 0.08% to 0.3%, 0.08% to 0.28%, 0.08% to 0.25%, 0.08% to 0.22%, 0.08% to 0.2%, 0.08% to 0.18%, or 0.08% to 0.15%.

In the above specific embodiments, when the conductive carbon black includes 0.05% to 0.3% of oxygen element, and/or the conductive carbon black includes 0.05% to 0.3% of hydrogen element, the oxygen-containing functional groups can enhance the chemical adsorption between the conductive carbon black and the positive electrode active material, promoting the transfer of electrons from the conductive carbon black to the active material. The hydrogen-containing structure adjusts the electron cloud distribution of the conductive carbon black to a certain extent, improving the intrinsic conductivity of the conductive carbon black, thereby improving the energy conversion efficiency of the electrochemical apparatus. In addition, oxygen element can participate in forming stable chemical bonds, helping to maintain the lattice structure of the electrode material and resist lattice distortion caused by high temperatures. Hydrogen element can assist in adjusting the microenvironment around the electrode material through weak interactions such as hydrogen bonds, alleviating stress concentration caused by high temperatures, and improving the stability and safety of the electrochemical apparatus in high-temperature environments.

In some specific embodiments, the conductive carbon black satisfies at least one of the following: (1) based on the total mass of the conductive carbon black, the conductive carbon black includes 100 ppb to 500 ppb of magnetic impurities, for example, the content of magnetic impurities in the conductive carbon black may be 100 ppb, 150 ppb, 200 ppb, 250 ppb, 300 ppb, 350 ppb, 400 ppb, 450 ppb, 500 ppb, or a range defined by any of these values; (2) based on the total mass of the conductive carbon black, the conductive carbon black includes 50 ppb to 500 ppb of ash, for example, the content of ash in the conductive carbon black may be 50 ppb, 100 ppb, 150 ppb, 200 ppb, 250 ppb, 300 ppb, 350 ppb, 400 ppb, 450 ppb, 500 ppb, or a range defined by any of these values; (3) a loss temperature of the volatile component in the conductive carbon black is 550° C. to 950° C., for example, it may be 550° C., 580° C., 600° C., 620° C., 650° C., 680° C., 700° C., 720° C., 750° C., 780° C., 800° C., 820° C., 850° C., 880° C., 900° C., 920° C., 950° C., or a range defined by any of these values; (4) Dᵥ50 of the conductive carbon black is 1000 nm to 6000 nm, for example, it may be 1000 nm, 1200 nm, 1500 nm, 1800 nm, 2000 nm, 2200 nm, 2500 nm, 2800 nm, 3000 nm, 3200 nm, 3500 nm, 3800 nm, 4000 nm, 4200 nm, 4500 nm, 4800 nm, 5000 nm, 5200 nm, 5500 nm, 5800 nm, 6000 nm, or a range defined by any of these values; (5) an average particle size of the carbon black units is 30 nm to 70 nm, for example, it may be 30 nm, 32 nm, 35 nm, 38 nm, 40 nm, 42 nm, 45 nm, 48 nm, 50 nm, 52 nm, 55 nm, 58 nm, 60 nm, 62 nm, 65 nm, 68 nm, 70 nm, or a range defined by any of these values; (6) a powder resistivity of the conductive carbon black is 25 mΩ·cm to 45 mΩ·cm, for example, it may be 25 mΩ·cm, 28 mΩ·cm, 30 mΩ·cm, 32 mΩ·cm, 35 mΩ·cm, 38 mΩ·cm, 40 mΩ·cm, 42 mΩ·cm, 45 mΩ·cm, or a range defined by any of these values; (7) a full width at half maximum of a (002) crystal plane diffraction peak in an X-ray diffraction pattern of the conductive carbon black is 10 to 5°, for example, it may be 10, 1.2°, 1.5°, 1.8°, 2°, 2.2°, 2.5°, 2.8°, 3°, 3.2°, 3.5°, 3.8°, 4°, 4.2°, 4.5°, 4.8°, 5°, or a range defined by any of these values; (8) a ratio of a peak value at 1700-1730 cm⁻¹ to a peak value at 2500-3000 cm⁻¹ in an infrared absorption spectrum of the conductive carbon black is 0.2 to 0.7, for example, it may be 0.2, 0.22, 0.25, 0.28, 0.3, 0.32, 0.35, 0.38, 0.4, 0.42, 0.45, 0.48, 0.5, 0.52, 0.55, 0.58, 0.6, 0.62, 0.65, 0.68, 0.7, or a range defined by any of these values; (9) the conductive carbon black includes a core formed by stacking a plurality of carbon black units and a plurality of branches connected to the core; or (10) Dᵥ50 of the conductive carbon black is C nm, an average particle size of the carbon black units is D nm, and the conductive carbon black satisfies: 25≤C/D≤150, for example, it may be 25, 30, 35, 40, 45, 50, 65, 70, 75, 80, 85, 90, 95, 100, 105, 110, 115, 120, 125, 130, 135, 140, 145, 150, or a range defined by any of these values.

Optionally, Dᵥ50 of the conductive carbon black may be 1300 nm to 3000 nm, 1500 nm to 6000 nm, 1500 nm to 5800 nm, 1500 nm to 5600 nm, 1500 nm to 5400 nm, 1500 nm to 5200 nm, or 1500 nm to 5000 nm.

Optionally, the average particle size of the carbon black units may be 32 nm to 70 nm, 35 nm to 70 nm, 38 nm to 70 nm, 40 nm to 70 nm, 40 nm to 68 nm, 40 nm to 65 nm, 40 nm to 62 nm, or 40 nm to 60 nm.

Optionally, the powder resistivity of the conductive carbon black may be 28 mΩ·cm to 45 mΩ·cm, 30 mΩ·cm to 45 mΩ·cm, 30 mΩ·cm to 44 mΩ·cm, 30 mΩ·cm to 43 mΩ·cm, 30 mΩ·cm to 42 mΩ·cm, 30 mΩ·cm to 41 mΩ·cm, or 30 mΩ·cm to 40 mΩ·cm.

Optionally, the full width at half maximum of the (002) crystal plane diffraction peak in the X-ray diffraction pattern of the conductive carbon black may be 1.2° to 5°, 1.5° to 5°, 1.50 to 4.8°, 1.50 to 4.5°, 1.50 to 4.2°, 1.50 to 4° 1.50 to 3.8°, 1.50 to 3.5° 1.50 to 3.2°, or 1.5° to 3°.

Optionally, the ratio of the peak value at 1700-1730 cm⁻¹ to the peak value at 2500-3000 cm⁻¹ in the infrared absorption spectrum of the conductive carbon black may be 0.22 to 0.7, 0.25 to 0.7, 0.28 to 0.7, 0.3 to 0.7, 0.3 to 0.68, 0.3 to 0.65, 0.3 to 0.62, or 0.3 to 0.6.

In the above specific embodiments, when the conductive carbon black includes 100 ppb to 500 ppb of magnetic impurities, an internal structure of the electrochemical apparatus can be kept stable, and capacity loss caused by problems such as short circuits can be reduced. In addition, since the reduction potential of metal impurity ions is lower than that of lithium ions, during charging, metal impurity ions are first intercalated into a carbon negative electrode to occupy intercalation positions for lithium ions, reducing the reversible capacity of a lithium-ion electrochemical apparatus. During high-temperature cycling, this effect is gradually accumulated, leading to rapid capacity decay of the electrochemical apparatus. When the conductive carbon black includes 100 ppb to 500 ppb of magnetic impurities, lithium ions can be more fully intercalated and deintercalated during charging and discharging, reducing irreversible capacity loss, thereby increasing a high-temperature cycling retention rate of the electrochemical apparatus. When the magnetic impurities are excessive, side reactions occur during cycling of the electrochemical apparatus, reducing the cycling capacity retention rate.

When the conductive carbon black includes 50 ppb to 500 ppb of ash, the conductive carbon black particles may be in better contact with each other, forming a more effective conductive network, and allowing smoother electron transport during charging and discharging of the electrochemical apparatus. During high-temperature cycling, the internal chemical reactions of the electrochemical apparatus are intense, and good conductivity helps to maintain stable performance of the electrochemical apparatus, reducing energy loss and heat generation of the electrochemical apparatus caused by increased resistance, and reducing the probability of side reactions. In high-temperature environments, the impact of side reactions is more significant, and reducing side reactions helps to maintain the stability of an internal chemical system of the electrochemical apparatus, allowing the electrochemical apparatus to maintain higher capacity after multiple cycles, thereby increasing the high-temperature cycling retention rate. When the content of ash is excessive, side reactions occur during cycling of the electrochemical apparatus, reducing the cycling capacity retention rate.

When the loss temperature of the volatile component in the conductive carbon black is 550° C. to 950° C., the conductive carbon black does not undergo significant changes in structure and performance due to large loss of the volatile component, thereby maintaining its own morphology and conductivity, maintaining a good conductive network inside the electrochemical apparatus, and ensuring smooth electron transport. Moreover, the volatile component is relatively stable within an operating temperature range of the electrochemical apparatus and is not prone to decomposition or participation in other side reactions, thereby helping to increase the high-temperature cycling retention rate of the electrochemical apparatus. When the loss temperature of the volatile component is too high, carbon chains where functional groups are located are longer, and excessively long carbon chains lead to reduced proportion and uneven attachment of the functional groups, thus making the dispersion of the conductive carbon black poor and prone to agglomeration. When the loss temperature of the volatile component is too low, the carbon chains where the functional groups are located are shorter and prone to decomposition reactions, thus affecting the performance of the electrochemical apparatus. When Dᵥ50 of the conductive carbon black is 1000 nm to 6000 nm, the conductive carbon black can form a relatively continuous conductive path in the electrode, allowing for shorter paths and lower resistance for electron transport. When the electrochemical apparatus is discharged at high rates, the demand for rapid conduction of a large number of electrons can be met, thereby improving the discharge rate performance of the electrochemical apparatus and allowing the electrochemical apparatus to release more electricity in a short time. In addition, when the electrode material expands, the conductive carbon black particles can be squeezed and deformed to a certain extent, absorbing part of the thermal stress, thereby alleviating the overall swelling of the electrode and reducing the cell thickness swelling rate.

When the average particle size of the carbon black units is 30 nm to 70 nm, the conductive carbon black can be in full contact with the electrode material, providing more conductive sites. This helps to form a dense conductive network inside the electrode, making electron transport paths more abundant, thereby reducing the internal resistance of the electrochemical apparatus. During high-rate discharge, electrons can be transported more quickly between the electrode material and the conductive carbon black, improving the discharge efficiency of the electrochemical apparatus, thereby improving the discharge rate performance. In addition, tiny pores and grain boundaries of the electrode material can be filled with fine carbon black particles. During high-temperature storage, these fine carbon black particles can provide a certain supporting effect, limiting the thermal expansion and lattice changes of the electrode material particles, thereby suppressing the overall swelling of the electrode and reducing the cell thickness swelling rate. When the average particle size of the carbon black units is too small, the binder is consumed, thus increasing the cell swelling rate at high temperatures. In addition, an excessively small average particle size of the carbon black units is also prone to uneven dispersion, reducing the rate performance of the electrochemical apparatus.

When the powder resistivity of the conductive carbon black is 25 mΩ·cm to 45 mΩ·cm, the overall resistance of the electrode can be effectively reduced, allowing for rapid electron transport in the electrode material and increasing the rate of electrochemical reactions during charging and discharging. Moreover, this helps to form a uniform electric field distribution inside the electrochemical apparatus, making the electrochemical reactions on the electrode surface more uniform and avoiding reaction imbalance in local regions due to excessively high or low electric field strength. During high-temperature cycling, the uniform reactions help to reduce local loss and polarization of the electrode material, prolonging the service life of the electrochemical apparatus, and increasing the high-temperature cycling retention rate of the electrochemical apparatus.

When the full width at half maximum of the (002) crystal plane diffraction peak in the X-ray diffraction pattern of the conductive carbon black is 1° to 5°, the surface of the conductive carbon black has more active sites. During charging and discharging of the electrochemical apparatus, these active sites can promote the electrochemical reactions between the electrode material and the electrolyte, increasing the reaction rate. Under high-temperature cycling conditions, an internal chemical reaction rate of the electrochemical apparatus accelerates, and more active sites help to maintain higher reaction efficiency, allowing the electrochemical apparatus to perform charging and discharging more fully. In addition, the conductive carbon black is better combined with the electrode material, enhancing interface adhesion. During high-temperature cycling of the electrochemical apparatus, volume expansion and contraction of the electrode material occur due to charging and discharging, and good bonding can effectively buffer the stress caused by such volume changes, reduce shedding and pulverization of the electrode material, and maintain the integrity of the electrode structure, thereby increasing the high-temperature cycling retention rate of the electrochemical apparatus. When the full width at half maximum of the diffraction peak is too large, side reactions occur during cycling of the electrochemical apparatus, reducing the cycling capacity retention rate. When the full width at half maximum of the diffraction peak is too small, the binding ability between the conductive carbon black and the binder is weak, making the conductive carbon black difficult to disperse and prone to agglomeration, thereby reducing the coating of the conductive carbon black on the positive electrode active material and lowering the cycling capacity retention rate.

When the ratio of the peak value at 1700-1730 cm⁻¹ to the peak value at 2500-3000 cm⁻¹ in the infrared absorption spectrum of the conductive carbon black is 0.2 to 0.7, the conductive carbon black can interact with the electrode material through hydrogen bonding and other effects, improving the electron transport efficiency between the conductive carbon black and the electrode material. In addition, this helps to form good conductive channels and ion transport paths on the electrode surface, reducing obstacles to electron and ion transport, reducing the internal resistance of the electrochemical apparatus, and reducing energy loss inside the electrochemical apparatus, thereby improving the energy conversion efficiency of the electrochemical apparatus. Moreover, this helps to improve the interface compatibility between the electrode and the electrolyte. Hydroxyl and other functional groups can interact with some components in the electrolyte, consuming substances that may cause side reactions, inhibiting decomposition of the electrolyte at high temperatures and side reactions on the electrode surface, and reducing gas and heat generation, thereby lowering the internal pressure of the electrochemical apparatus and suppressing cell thickness swelling.

When the conductive carbon black includes the core formed by stacking the plurality of carbon black units and the plurality of branches connected to the core, the core formed by stacking the plurality of carbon black units provides a main channel for electron transport, reducing the resistance to electron transport. The branches connected to the core increase contact points and contact area between the conductive carbon black and the electrode material, allowing electrons to be transported to various parts of the electrode material more quickly and efficiently through the branches, thereby forming a more complete and efficient conductive network inside the electrochemical apparatus. During high-temperature cycling, the internal chemical reaction rate of the electrochemical apparatus accelerates, and the requirement for electron transport efficiency is higher. This structure can ensure rapid conduction of electrons and maintain the charging and discharging performance of the electrochemical apparatus, thereby increasing the high-temperature cycling retention rate.

When the conductive carbon black satisfies 25≤C/D≤150, a multi-level structure with both larger particles for support and fine particles for tight filling can be formed. This structure is conducive to constructing a stable and efficient conductive network inside the electrode. Their synergistic effect can promote adsorption and desorption of lithium ions, thereby reducing the internal resistance of the electrochemical apparatus and increasing the discharge rate. Moreover, agglomeration and deformation of the electrode material at high temperatures can be reduced, and local overheating and intensification of side reactions can be suppressed, thereby lowering internal pressure of the electrochemical apparatus and suppressing cell thickness swelling. When C/D is too large, the interaction between conductive carbon black particles is strong, making dispersion difficult, thus causing uneven dispersion of the conductive carbon black and affecting the performance of the electrochemical apparatus.

It should be noted that the content of the magnetic impurities in the conductive carbon black, the content of ash, the loss temperature of the volatile component, Dᵥ50, the powder resistivity, the average particle size of the carbon black units, the full width at half maximum of the (002) crystal plane diffraction peak in the X-ray diffraction pattern of the conductive carbon black, the ratio of the peak value at 1700-1730 cm⁻¹ to the peak value at 2500-3000 cm⁻¹ in the infrared absorption spectrum of the conductive carbon black, and morphology of the conductive carbon black can be detected using methods and instruments known in the art. For example, the positive electrode plate can be obtained by disassembling the electrochemical apparatus and then further disassembled to obtain the conductive carbon black. A vibrating sample magnetometer method (VSM) is used, a sample is placed in a measurement system of the VSM, and appropriate measurement parameters such as a magnetic field strength range and vibration frequency are set. An instrument automatically measures a magnetic moment of the sample under different magnetic field strengths and plots a hysteresis loop. Based on characteristic parameters of the hysteresis loop, such as saturation magnetization, combined with the known magnetization characteristics of magnetic impurities, the content of the magnetic impurities is calculated through a specific algorithm. A high-temperature incineration method is used, and a crucible containing the sample is placed in a high-temperature furnace, gradually heated to (815±10°) C, and incinerated at this temperature until the sample is completely ashed to obtain a total mass of ash. A thermogravimetric analysis (TGA) is used, the prepared conductive carbon black sample is weighed and placed in a crucible, and the crucible containing the sample is placed in a thermogravimetric analyzer again, heated at the same heating speed as the blank test to obtain a thermogravimetric curve (TG curve) and a derivative thermogravimetric curve (DTG curve). The TG and DTG curves are combined to determine a loss temperature range of the volatile component in the conductive carbon black. Dᵥ50 of the conductive carbon black can be measured using a laser particle size analyzer. A two-electrode method is used, and two electrodes are inserted into a sample cell and brought into good contact with the conductive carbon black powder. A distance between the electrodes needs to be accurately measured and recorded. A resistivity tester is used to measure a resistance value of the sample and calculate the powder resistivity of the conductive carbon black. An electron microscopy method is used, and a conductive carbon black sample is uniformly dispersed on a sample stage. For example, the sample can be ultrasonically dispersed in a solvent such as ethanol and then dropped on a copper grid or other sample stages. After the solvent evaporates, the sample is placed in an electron microscope for observation. A particle size of multiple particles is measured using a measurement tool of a microscope, and then statistical analysis is performed to obtain the average particle size of the carbon black units and the morphology of the conductive carbon black. An X-ray diffraction pattern of the conductive carbon black is obtained using XRD measurement, and the full width at half maximum of the (002) crystal plane diffraction peak in the X-ray diffraction pattern of the conductive carbon black is determined based on the X-ray diffraction pattern. An infrared absorption spectrum of the conductive carbon black is measured using a Fourier transform infrared spectrometer, and the ratio of the peak value at 1700-1730 cm⁻¹ to the peak value at 2500-3000 cm⁻¹ in the infrared absorption spectrum of the conductive carbon black is analyzed based on the infrared absorption spectrum.

### Positive Electrode Plate

Some embodiments of this application provide a positive electrode plate, where the positive electrode plate includes a binder, positive electrode active material particles, and a conductive agent. The conductive agent includes the above conductive carbon black and carbon nanotubes. The positive electrode plate has good lithium ion transport and structural stability, thereby improving the performance of an electrochemical apparatus.

In some specific embodiments, the positive electrode plate satisfies at least one of the following: (1) a specific surface area of the conductive agent is E m²/g, based on a total mass of the positive electrode plate, the positive electrode plate includes W₁% of the conductive agent and W₂% of the binder, and the positive electrode plate satisfies: 0.004×E×W₁≤W₂≤0.014×E×W₁, for example, E×W₁/W₂ maybe 0.004, 0.006, 0.008, 0.010, 0.012, 0.014, or a range defined by any of these values; (2) a specific surface area of the conductive agent is 40 m²/g to 300 m²/g, for example, the specific surface area of the conductive agent may be 40 m²/g, 50 m²/g, 100 m²/g, 150 m²/g, 200 m²/g, 250 m²/g, 300 m²/g, or a range defined by any of these values; (3) based on a total mass of the positive electrode plate, the positive electrode plate includes 0.5% to 3% of the conductive agent, for example, the percentage of the conductive agent may be 0.5%, 0.8%, 1%, 1.2%, 1.5%, 1.8%, 2%, 2.2%, 2.5%, 2.8%, 3%, or a range defined by any of these values; (4) based on a total mass of the positive electrode plate, the positive electrode plate includes 0.5% to 5% of the binder, for example, the percentage of the binder may be 0.5%, 0.8%, 1%, 1.2%, 1.5%, 1.8%, 2%, 2.2%, 2.5%, 2.8%, 3%, 3.2%, 3.5%, 3.8%, 4%, 4.2%, 4.5%, 4.8%, 5%, or a range defined by any of these values; or (5) a mass ratio of the conductive carbon black to the carbon nanotubes in the conductive agent is 0.6 to 2, for example, it may be 0.6, 0.7, 0.8, 0.9, 1, 1.1, 1.2, 1.3, 1.4, 1.5, 1.6, 1.7, 1.8, 1.9, 2, or a range defined by any of these values.

Optionally, 0.005×E×W₁≤W₂≤0.014×E×W₁, 0.006×E×W₁≤W₂≤0.014×E×W₁, 0.007×E×W₁≤W₂≤0.014×E×W₁, 0.005×E×W₁≤W₂≤0.013×E×W₁, or 0.007×E×W₁≤W₂≤0.012×E×W₁.

Optionally, the specific surface area of the conductive agent may be 60 m²/g to 300 m²/g, 80 m²/g to 300 m²/g, 100 m²/g to 300 m²/g, 100 m²/g to 280 m²/g, 100 m²/g to 260 m²/g, 100 m²/g to 240 m²/g, 100 m²/g to 220 m²/g, or 100 m²/g to 200 m²/g.

Optionally, the percentage of the conductive agent may be 0.6% to 3%, 0.7% to 3%, 0.8% to 3%, 0.8% to 2.9%, 0.8% to 2.8%, 0.8% to 2.7%, 0.8% to 2.6%, or 0.8% to 2.5%.

Optionally, the percentage of the binder may be 0.8% to 5%, 1% to 5%, 1% to 4.8%, 1% to 4.5%, 1% to 4.2%, 1% to 4%, 1% to 3.8%, 1% to 3.5%, 1% to 3.2%, or 1% to 3%.

In the above specific embodiments, when the positive electrode plate satisfies 0.004×E×W₁≤W₂≤0.014×E×W₁, the binder can better bond the conductive agent and an active material together, allowing the conductive agent to be uniformly dispersed in the active material, and forming an efficient conductive network. In addition, an appropriate amount of binder does not excessively block electrode pores, ensuring electrolyte penetration and lithium ion transport channels, thereby reducing the internal resistance of the electrochemical apparatus and increasing the discharge rate. Moreover, the interface compatibility between an electrode and an electrolyte can be improved, reducing decomposition of the electrolyte at high temperatures and side reactions on an electrode surface. Good interface compatibility helps to reduce reaction resistance on the electrode surface, making the reaction more uniform, and reducing local overheating and gas generation. Reduced gas generation can lower the internal pressure of the electrochemical apparatus, thereby suppressing cell thickness swelling.

When the specific surface area of the conductive agent is 40 m²/g to 300 m²/g, the conductive agent has more abundant pore structures and greater surface energy. The pore structures are conducive to adsorption and storage of the electrolyte, providing more transport channels for lithium ions, and accelerating the diffusion rate of lithium ions in the electrode material. The time for lithium ions to migrate from the interior to the surface of the active material is shortened, thereby improving the lithium ion supply rate during high-rate discharge of the electrochemical apparatus and increasing the discharge rate. In addition, better support can be provided between active material particles, improving the stability of the electrode structure. In high-temperature environments, the active material may undergo thermal expansion and structural changes, and the conductive agent with a large specific surface area and good dispersion can restrict excessive movement and agglomeration of the active material particles, maintaining the integrity of the electrode structure, thereby reducing the cell thickness swelling rate.

When the positive electrode plate includes 0.5% to 3% of the conductive agent and/or 0.5% to 5% of the binder, the electrode porosity can be increased, which is conducive to electrolyte penetration and lithium ion diffusion. The conductive agent and the binder are synergized with the conductive network, so that the lithium ion migration rate is increased, thereby increasing the discharge rate of the electrochemical apparatus. In addition, the conductive agent and the binder can improve the interface performance between the electrode and the electrolyte. The binder prevents excessive contact between the electrolyte and the active material, suppressing side reactions. The conductive agent promotes charge transfer on the electrode surface, making the reaction more uniform and reducing local overheating and gas generation. Their combined effect lowers the internal pressure of the electrochemical apparatus, thereby suppressing cell thickness swelling.

When the mass ratio of the conductive carbon black to the carbon nanotubes in the conductive agent is 0.6 to 2, their synergistic effect helps to optimize the pore structure and surface properties inside the electrode. The porous structure of the conductive carbon black can adsorb more electrolyte, providing abundant transport channels and storage sites for lithium ions. The presence of carbon nanotubes can further guide the transport direction of lithium ions, allowing lithium ions to be diffused more quickly and uniformly in the electrode material. Therefore, during charging and discharging, lithium ions can be more efficiently intercalated and deintercalated between the active material and the electrolyte, thereby increasing the discharge rate of the electrochemical apparatus. Moreover, in high-temperature environments, the synergistic effect of the conductive carbon black and the carbon nanotubes can improve the stability of the electrode structure. The conductive carbon black can be filled between active material particles, providing buffer and support, reducing mutual squeezing and deformation of the active material particles due to thermal expansion. The carbon nanotubes can interpenetrate the entire electrode structure like a “skeleton”, improving the overall mechanical strength of the electrode and restricting displacement and agglomeration of the active material particles. Their synergistic effect can form a stable three-dimensional structure, effectively suppressing swelling and deformation of the electrode at high temperatures, thereby reducing the cell thickness swelling rate.

It should be noted that the percentage of the conductive agent in the positive electrode plate, the specific surface area of the conductive agent, the percentage of the binder, and the mass ratio of the conductive carbon black to the carbon nanotubes in the conductive agent can be detected using methods and instruments known in the art. For example, the positive electrode plate can be obtained by disassembling the electrochemical apparatus. For example, a solvent extraction method is used; by taking advantage of the characteristic that the binder is soluble in some specific solvents while the conductive agent and active material are insoluble, the binder is extracted from the electrode plate, and then the percentage of the binder is determined by weighing or other methods, and the percentage of the conductive agent is calculated. A thermogravimetric analysis method is used; since the thermal stability of conductive carbon black and carbon nanotubes differs at high temperatures, the thermal stability of carbon nanotubes is typically relatively high, and the weight loss in a certain temperature range is smaller than that of conductive carbon black. By analyzing the weight loss in different temperature stages of the thermogravimetric curve, the two can be distinguished, and their mass ratio can be calculated based on the weight loss proportion.

### Electrochemical Apparatus

This application provides an electrochemical apparatus. The electrochemical apparatus includes the above positive electrode plate, a negative electrode plate, a separator, and an electrolyte. The electrochemical apparatus has low internal resistance and low cell thickness swelling rate during high-temperature storage as well as high high-temperature cycling capacity retention rate and charging and discharging performance.

In some specific embodiments, the electrochemical apparatus satisfies at least one of the following: (1) based on a total mass of the electrolyte, the electrolyte includes Z % of a dinitrile additive, a specific surface area of the conductive agent is E m²/g, and the electrochemical apparatus satisfies: 50≤E/Z≤1000, for example, E/Z may be 50, 100, 200, 300, 400, 500, 600, 700, 800, 900, 1000, or a range defined by any of these values; (2) based on a total mass of the electrolyte, the electrolyte includes 0.5% to 5% of 2,2-difluoroethyl acetate, for example, the percentage of 2,2-difluoroethyl acetate may be 0.5%, 0.8%, 1%, 1.2%, 1.5%, 1.8%, 2%, 2.2%, 2.5%, 2.8%, 3%, 3.2%, 3.5%, 3.8%, 4%, 4.2%, 4.5%, 4.8%, 5%, or a range defined by any of these values; (3) Dᵥ50 of the positive electrode active material particles is G m, based on a total mass of the electrolyte, the electrolyte includes X % of propyl propionate, and the electrochemical apparatus satisfies: 2≤G/X≤5, for example, G/X may be 2, 2.2, 2.5, 2.8, 3, 3.2, 3.5, 3.8, 4, 4.2, 4.5, 4.8, 5, or a range defined by any of these values; (4) Dᵥ50 of the positive electrode active material particles is 5 μm to 25 μm, for example, it may be 5 μm, 8 μm, 10 μm, 12 μm, 15 μm, 18 μm, 20 μm, 22 μm, 25 μm, or a range defined by any of these values; or (5) based on a total mass of the electrolyte, the electrolyte includes 5% to 30% of propyl propionate, for example, the percentage of propyl propionate may be 5%, 8%, 10%, 12%, 15%, 18%, 20%, 22%, 25%, 28%, 30%, or a range defined by any of these values.

In the above specific embodiments, when the electrochemical apparatus satisfies 14.2≤E/Z≤7500, the dinitrile additive can form a stable solid electrolyte interface (SEI) film on an electrode surface. The film can prevent further reaction between an electrolyte and an electrode material, and reduce corrosion and dissolution of the electrode material, thereby improve the cycling stability of the electrochemical apparatus. A high specific surface area of the conductive carbon black helps to uniformly distribute the active material on the electrode surface, reduce agglomeration and shedding of the active material, and also facilitate uniform formation of the SEI film, ensuring the synergistic effect of the additive and the conductive carbon black in improving cycling stability, and allowing the electrochemical apparatus to still maintain good performance after multiple charge-discharge cycles. In addition, their synergistic effect makes charge transport inside the electrochemical apparatus more efficient and the charging and discharging process smoother.

The electrolyte including 0.02% to 12.5% 2,2-difluoroethyl acetate based on the total mass of the electrolyte helps to maintain the fluidity of the electrolyte in low-temperature environments, allowing smoother ion transport inside the electrochemical apparatus, thereby improving the charging and discharging efficiency and capacity of the electrochemical apparatus at low temperatures, and reducing performance degradation of the electrochemical apparatus at low temperatures. In addition, the additive can form a stable solid electrolyte interface (SEI) film on the electrode surface. This film can prevent side reactions between the electrolyte and the electrode material, reduce corrosion and dissolution of the electrode material, and suppress loss of active material, thereby prolonging the cycle life of the electrochemical apparatus and allowing the electrochemical apparatus to still maintain good performance after multiple charge-discharge cycles. However, excessive 2,2-difluoroethyl acetate causes reduced electrolyte conductivity, making the CEI film loose, thus reducing the cycling performance and rate performance of the electrochemical apparatus. More preferably, based on the total mass of the electrolyte, the mass percentage of 2,2-difluoroethyl acetate is 0.5% to 5%, which can better improve the cycling performance and rate performance of the electrochemical apparatus.

The electrochemical apparatus satisfying 0.125≤G/X≤0.83 helps to achieve good matching between the positive electrode active material particles and propyl propionate in the electrolyte. Propyl propionate can better wet the surface of the active material particles, increasing a contact area between the electrode and the electrolyte, facilitating ion transport at an interface, and reducing interface resistance, thereby improving the charging and discharging efficiency of the electrochemical apparatus. When G/X is too small, the Li⁺ content in the electrolyte is diluted, reducing the conductivity of the electrochemical apparatus, and the formed CEI film is loose and excessively thick, thus reducing the cycling performance and rate performance of the electrochemical apparatus.

It should be noted that the components in the electrolyte can be detected using methods and instruments known in the art. For example, the electrolyte can be obtained by disassembling the electrochemical apparatus. An ion chromatography (IC) is used for testing, some components in the electrolyte (such as lithium salts) are qualitatively determined by retention time, and corresponding types and mass percentages are calculated through peak areas. A gas chromatography-mass spectrometry (GC-MS) is used to detect types and mass percentages of some components (such as organic solvents) in the electrolyte.

The following embodiments can enable those skilled in the art to more fully understand this application, but do not limit this application in any way.

In some embodiments, the types of the additives included in the electrolyte may also include ethylene sulfate (DTD), vinylene sulfate (VC), and 1,3-propane sultone, and may further include fluoromethyl methyl carbonate, difluoromethyl methyl carbonate, trifluoromethyl methyl carbonate, trifluoroethyl methyl carbonate, or bis(trifluoroethyl) carbonate.

In some embodiments, in addition to LiFSI and LiPO₂F₂, the electrolyte may also include an ionizable lithium salt. The ionizable lithium salt includes at least one of LiPF₆, LiSbF₆, LiAsF₆, LiClO₄, LiN(C₂F₅SO₂)₂, CF₃SO₃Li, LiC(CF₃SO₂)₃, or LiC₄BO₈. The concentration of the ionizable lithium salt in the electrolyte is not particularly limited and is preferably 0.5 mol/L or more, more preferably 0.8 mol/L or more, and further preferably 1.0 mol/L or more. In addition, the concentration of the ionizable lithium salt is preferably 3 mol/L or less, more preferably 2 mol/L or less, and further preferably 1.7 mol/L or less. If the concentration of the ionizable lithium salt is too low, the number of movable lithium ions in the electrolyte may be insufficient. On the other hand, if the concentration of the ionizable lithium salt is too high, the viscosity of the electrolyte may be increased, resulting in increased impedance of the electrolyte, and reducing the lithium ion migration rate, thus possibly leading to degraded performance of the electrochemical apparatus.

In some embodiments, the electrolyte may also include at least one of fluoroether, fluorinated vinylene carbonate, or ether solvent. In some embodiments, the electrolyte may also include a non-aqueous solvent. The non-aqueous solvent may be a carbonate compound, a carboxylate compound, an ether compound, another organic solvent, or a combination thereof.

In addition to a linear carbonate compound, the carbonate compound may also include a cyclic carbonate compound, a fluorinated carbonate compound, or a combination thereof.

In addition to diethyl carbonate (DEC) defined in this application, examples of the linear carbonate compound may include ethyl propionate (EP), dimethyl carbonate (DMC), dipropyl carbonate (DPC), methyl propyl carbonate (MPC), ethyl propyl carbonate (EPC), methyl ethyl carbonate (MEC), and a combination thereof. Examples of the cyclic carbonate compound include ethylene carbonate (EC), propylene carbonate (PC), butylene carbonate (BC), vinyl ethylene carbonate (VEC), or a combination thereof. Examples of the fluorinated carbonate compound include fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methyl ethylene carbonate, 1-fluoro-1-methyl ethylene carbonate, 1,2-difluoro-1-methyl ethylene carbonate, 1,1,2-trifluoro-2-methyl ethylene carbonate, trifluoromethyl ethylene carbonate, or a combination thereof.

Examples of the carboxylate compound include methyl acetate, ethyl acetate, n-propyl acetate, tert-butyl acetate, methyl propionate, ethyl propionate, propyl propionate, γ-butyrolactone, decanolide, valerolactone, mevalonic lactone, caprolactone, methyl formate, or a combination thereof.

Examples of the ether compound include dibutyl ether, tetraglyme, diglyme, 1,2-dimethoxyethane, 1,2-diethoxyethane, ethoxymethoxyethane, 2-methyltetrahydrofuran, tetrahydrofuran, or a combination thereof.

Examples of the another organic solvent include dimethyl sulfoxide, 1,2-dioxolane, sulfolane, methyl sulfolane, 1,3-dimethyl-2-imidazolidinone, N-methyl-2-pyrrolidone, formamide, dimethylformamide, acetonitrile, trimethyl phosphate, triethyl phosphate, trioctyl phosphate, phosphate, or a combination thereof.

This application further provides an electrochemical apparatus including the above electrolyte. In some embodiments, the electrochemical apparatus further includes a positive electrode plate, a negative electrode plate, and a separator, where the positive electrode plate and the negative electrode plate are separated by the separator disposed therebetween. In some embodiments, the positive electrode plate includes a positive electrode current collector and a positive electrode active material layer disposed on the positive electrode current collector. The positive electrode active material layer may include a positive electrode active material and an auxiliary agent. The negative electrode plate includes a negative electrode current collector and a negative electrode active material layer disposed on the negative electrode current collector. The negative electrode active material layer may include a negative electrode active material.

In some embodiments, the negative electrode plate may include a negative electrode current collector and a negative electrode active material layer disposed on the negative electrode current collector. The negative electrode active material layer may be disposed on one side or both sides of the negative electrode current collector. In some embodiments, the negative electrode current collector may be at least one of a copper foil, a nickel foil, or a carbon-based current collector. In some embodiments, a thickness of the negative electrode current collector may be 1 μm to 200 μm. In some embodiments, the negative electrode active material layer may be applied only on a partial region of the negative electrode current collector. In some embodiments, a thickness of the negative electrode active material layer may be 10 μm to 500 μm. It should be understood that these are merely exemplary and other suitable thicknesses may be used.

In some embodiments, as described above, the negative electrode active material layer includes a negative electrode active material. In some embodiments, the negative electrode active material includes at least one of natural graphite, artificial graphite, or a silicon-based material. In some embodiments, the silicon-based material includes at least one of silicon, a silicon-oxygen compound, a silicon-carbon compound, or silicon alloy.

In some embodiments, the negative electrode active material layer may further include a negative electrode conductive agent and/or a negative electrode binder. The negative electrode conductive agent may include at least one of carbon black, acetylene black, Ketjen black, graphene, carbon nanotubes, or carbon fiber. In some embodiments, the negative electrode binder may include at least one of carboxymethyl cellulose (CMC), polyacrylic acid, polyacrylate salt, polyacrylate ester, polyvinylpyrrolidone, polyimide, polysiloxane, or styrene-butadiene rubber. It should be understood that the materials disclosed above are merely exemplary, and the negative electrode active material layer may use any other suitable materials. In some embodiments, a mass ratio of the negative electrode active material, the negative electrode conductive agent, and the negative electrode binder in the negative electrode active material layer may be (80 to 99):(0.5 to 10):(0.5 to 10). It should be understood that this is merely exemplary and is not intended to limit this application.

In some embodiments, the positive electrode plate includes a positive electrode current collector and a positive electrode active material layer disposed on the positive electrode current collector. The positive electrode active material layer may be located on one side or both sides of the positive electrode current collector. In some embodiments, the positive electrode current collector may be an aluminum foil. Certainly, other positive electrode current collectors commonly used in the art may also be used. In some embodiments, a thickness of the positive electrode current collector may be 1 μm to 200 μm. In some embodiments, the positive electrode active material layer may be applied only on a partial region of the positive electrode current collector. In some embodiments, a thickness of the positive electrode active material layer may be 20 μm to 490 μm, more preferably 20 m to 400 μm, and further preferably 40 μm to 120 μm, and even further preferably 40 μm to 90 μm.

In some embodiments, as described above, the positive electrode active material layer includes a positive electrode active material. In some embodiments, the positive electrode active material may include at least one of lithium cobalt oxide, lithium manganese oxide, lithium iron phosphate, lithium manganese iron phosphate, nickel cobalt manganese oxide lithium, nickel cobalt aluminum oxide lithium, or nickel manganese oxide lithium. The above positive electrode active material may be subjected to doping and/or coating treatment. Further preferably, the positive electrode active material is lithium cobalt oxide or lithium iron phosphate.

In some embodiments, a surface of the positive electrode material includes lithium phosphate and/or lithium niobate, where a mass ratio of the two is 1:3 to 1:1, and a thickness of a coating layer is 1 μm to 1.8 μm.

In some embodiments, the surface of the positive electrode material includes lithium dihydrogen phosphate or aluminum dihydrogen phosphate. Based on a total mass of the positive electrode active material layer, a mass percentage of lithium dihydrogen phosphate or aluminum dihydrogen phosphate is M %, and 5≤M≤20.

In some embodiments, a substrate of the separator includes at least one of polyethylene, polypropylene, polyvinylidene fluoride, polyethylene terephthalate, polyimide, or aramid. For example, polyethylene includes at least one selected from high-density polyethylene, low-density polyethylene, or ultra-high molecular weight polyethylene. In particular, polyethylene and polypropylene have a good effect on preventing short circuits and can improve the safety of the battery through a shutdown effect. In some embodiments, an overall thickness of the separator is in a range of about 3 μm to 480 μm.

In some embodiments, a surface of the separator may further include a porous layer. The porous layer is disposed on at least one surface of the separator. The porous layer includes inorganic particles and a binder. The inorganic particles are selected from at least one of aluminum oxide (Al₂O₃), silicon oxide (SiO₂), magnesium oxide (MgO), titanium oxide (TiO₂), hafnium dioxide (HfO₂), tin oxide (SnO₂), cerium dioxide (CeO₂), nickel oxide (NiO), zinc oxide (ZnO), calcium oxide (CaO), zirconium oxide (ZrO₂), yttrium oxide (Y₂O₃), silicon carbide (SiC), boehmite, aluminum hydroxide, magnesium hydroxide, calcium hydroxide, or barium sulfate. In some embodiments, pores of the separator have a diameter in a range of about 0.01 μm to 1 μm. The binder of the porous layer is selected from at least one of polyvinylidene fluoride, vinylidene fluoride-hexafluoropropylene copolymer, polyamide, polyacrylonitrile, polyacrylate ester, polyacrylic acid, polyacrylate salt, sodium carboxymethyl cellulose, polyvinylpyrrolidone, polyvinyl ether, polytetrafluoroethylene, or polyhexafluoropropylene. The porous layer on the surface of the separator can improve the heat resistance, oxidation resistance, and electrolyte infiltration of the separator and enhance the adhesion between the separator and an electrode plate. One surface of the separator may further include one of a high-melting-point crystalline polymer or a high-temperature-resistant amorphous polymer. The high-temperature-resistant resin includes at least one of polypropylene, poly(4-methylpentene), polytetrafluoroethylene, polyvinylidene fluoride, or cycloolefin copolymer. The high-melting-point crystalline polymer includes at least one of polypropylene, poly(4-methylpentene), polytetrafluoroethylene, or polyvinylidene fluoride. The high-temperature-resistant amorphous polymer includes a cycloolefin copolymer. Based on a mass of a polyolefin porous substrate, a mass percentage z of high-temperature-resistant resin is 2.5% to 9%. For example, the mass percentage z of the high-temperature-resistant resin is 2.5%, 3%, 5%, 7%, 8%, 9%, or a range defined by any two of these values. When the above type of high-temperature-resistant resin is added to the polyolefin porous substrate and the mass percentage of the high-temperature-resistant resin is adjusted within the above range, the increase in a melting rupture temperature of the separator is facilitated, improving the strength and the high-temperature performance of the electrochemical apparatus.

In some embodiments, the electrochemical apparatus is a lithium-ion battery, but this application is not limited thereto.

In some embodiments of this application, taking a lithium-ion battery as an example, a positive electrode plate, a separator, and a negative electrode plate are sequentially wound or stacked into an electrode assembly. Then, the electrode assembly is placed into a casing such as an aluminum-plastic film and then sealed, followed by electrolyte injection, formation, and packaging to produce a lithium-ion battery.

### Preparation Method of Conductive Carbon Black

A raw material natural gas is filled in a reaction furnace and undergoes a cracking reaction at a high temperature of 1000° C. to 1500° C. to generate carbon black particles. The carbon black particles are blown out from a furnace tube, cooled to room temperature, and then collected. This application has no particular limitation on the type of the above raw material as long as the objective of this application can be achieved. For example, the raw material may include but is not limited to acetylene or tar.

### Electronic Apparatus

Some embodiments of this application further provide an electronic apparatus including the above electrochemical apparatus. The electronic apparatus according to these embodiments of this application is not particularly limited and may be any electronic apparatus known in the prior art. In some embodiments, the electronic apparatus may include but is not limited to a notebook computer, a pen-input computer, a mobile computer, an electronic book player, a portable telephone, a portable fax machine, a portable copier, a portable printer, a stereo headset, a video recorder, a liquid crystal television, a portable cleaner, a portable CD player, a mini disc, a transceiver, an electronic notebook, a calculator, a memory card, a portable recorder, a radio, a backup power supply, a motor, an automobile, a motorcycle, a power-assisted bicycle, a bicycle, a lighting fixture, a toy, a game console, a timepiece, an electric tool, a flash lamp, a camera, a large household battery, and a lithium-ion capacitor.

### Testing Section

A testing method is as follows:

1. Under a Condition with an Ambient Temperature of 25° C. And a Battery State of Charge of 20%, the 1-Second Direct-Current Internal Resistance (1s DCR@25° C. 20% SOC) of the Battery:

A lithium-ion battery from the example or comparative example was taken and subjected to the following tests at 25±2° C.: (1) the battery was left standing for 2 h; (2) the battery was then charged at a constant current of 1.0 C to 4.50 V, then charged at a constant voltage of 4.50 V until the current was less than or equal to 0.025 C, and left standing for 2 h; (3) the battery was then discharged at a constant current of 0.2 C to 3.0 V, a discharge capacity of this step was taken as a variable C1, and the battery was then left standing for 5 h; (4) the battery was then charged at a constant current of 1.0 C1 to 4.3 V, then charged at a constant voltage of 4.3 V until the current was less than or equal to 0.025 C1, and left standing for 10 min; and (5) the battery was then discharged at a constant current of 0.1 C1 until the capacity was 0.2 C1 and left standing for 15 min, and a voltage of the battery was recorded as V0; then the battery was discharged at a constant current of 1.0 C1 for Is, and the voltage at this point was recorded as V1; and is DCR at 25° C. 20% SOC was (V0−V1)/1.0 C1.

2. Cell Thickness Swelling Rate after Storage at 85° C. For 8 h:

In an environment at 25±3° C., a cell was charged at a constant current of 0.5 C to 4.50 V and then charged at a constant voltage of 4.50 V to 0.025 C. An initial thickness of the cell it was tested and recorded as H1. The cell was placed in a high-temperature furnace at 85±3° C. for 8 h, then a cell thickness in situ was tested and recorded as T2. A cell thickness swelling rate after storage was recorded as (T2−T1)/T1.

### 3. Cycling Capacity Retention Rate:

A lithium-ion battery from the example or comparative example was taken and subjected to the following tests at 45±2° C.:
(1) The battery was left standing for 2 h, discharged at a constant current of 0.5 C to 3.0 V, and left standing for 5 min.
(2) The battery was charged at a constant current of 1.0 C to 4.5 V, charged at a constant voltage of 4.5 V until the current was less than or equal to 0.05 C, and left standing for 5 min. The battery was then discharged at a constant current of 0.5 C to 3.0 V, a discharge capacity at this point was recorded as C1. Then, the battery was left standing for 5 min. 49 cycles were performed according to the above steps; and then the 50th cycle was performed. In the 50th cycle, the battery was charged at a constant current of 1.0 C to 4.5 V, charged at a constant voltage of 4.5 V until the current was less than or equal to 0.05 C, and left standing for 5 min. Then, the battery was discharged at a constant current of 0.2 C to 3.0 V.
(3) Then, after 10 cycles were performed according to the above step (2), the battery was charged at a constant current of 1.0 C to 4.5 V, charged at a constant voltage of 4.5 V until the current was less than or equal to 0.05 C, and left standing for 5 min. Then, the battery was discharged at a constant current of 0.5 C to 3.0 V, and a capacity of the lithium-ion battery in the 501st cycle was recorded as C501. A capacity retention rate of the lithium-ion battery after 500 cycles at 45° C. was C501/C1.

### 4. Charge Rate:

A lithium-ion battery from the example or comparative example was taken and subjected to the following tests at 25±2° C.:
(1) The battery was left standing for 2 h, discharged at a constant current of 0.5 C to 3.0 V, and then left standing for 5 min.
(2) The battery was charged at a constant current of 1.0 C to 4.50 V, charged at a constant voltage of 4.5 V until the current was less than or equal to 0.05 C, and left standing for 5 min. Then, the battery was discharged at a constant current of 0.2 C to 3.0 V. A discharge capacity at this point was recorded as C₀.

Then, the battery was discharged at a constant current of 3.5 C₀ to 4.40 V, and then discharged at a constant current of 2.6 C₀ to 4.35 V. Then, the battery was discharged at a constant current of 2.2 C₀ to 4.48 V, then discharged at a constant current of 1.8 C₀ to 4.50 V, and then charged at a constant voltage of 4.50 V to 0.05 C₀. A total charging capacity during this process was recorded as C₁, a charging capacity of the part “the battery was discharged at a constant current of 3.5 C₀ to 4.40 V” was recorded C₂, and a discharge rate at 3.5 C was C₂/C₁.

### 5. Test for Volatile Component in Conductive Carbon Black:

A crucible and a crucible lid were first dried at 950° C. for half an hour, cooled to room temperature and then weighed. Conductive carbon black with a mass m was dried at 125° C. for 10 min. Then, the dried carbon black was poured into the dried crucible and covered with the crucible lid, with a total weight weighed as M1, which were together placed in a muffle furnace at 950° C., maintained at this temperature for 7 min, then air cooled to room temperature, with a total weight weighed as M2. A percentage of the volatile component was (M1−M2)/m, where m was 2 g.

### 6. Test for Specific Surface Area of Conductive Carbon Black:

A multi-point adsorption BET method was used. A dehydrated and degassed sample was placed into a sample tube of an instrument. At a liquid nitrogen temperature (77 K), nitrogen gas at different pressures was filled into the sample tube. An adsorption amount of the nitrogen gas on the sample surface was measured. Then, according to a BET equation, a reciprocal of the adsorption amount against the relative pressure was plotted to obtain a straight line; and a specific surface area of the sample could be calculated through the slope and intercept of the straight line.

### 7. Test for Elements in Conductive Carbon Black:

0.5 g of carbon powder was taken, digested with 10 ml nitric acid, and loaded into the ICP-OES, Avio 200 element tester for testing. During the testing process, a pumping speed of a device was adjusted to 1.5 mL/min, radio-frequency power was adjusted to 1300 W, an observation angle was vertical, an observation height was 15 ml, and after testing, results were directly output from the instrument.

### 8. Test for Magnetic Impurities in Conductive Carbon Black:

m0 (200 g) of conductive carbon was dissolved in 300 ml deionized water. The resulting mixture was placed in a two-dimensional horizontal rolling mixer. A magnetic rod with a length of 52 mm, a diameter of 17 mm, and magnetic field strength 6000±500 GS was used to adsorb magnetic impurities. A rotation speed of the mixer was 60 r/min. The time was 30 min. Then, the magnetic rod was taken out, and the magnetic impurities were washed off and then digested with 10 ml (1+1) aqua regia. Then, types of the magnetic impurities and a total mass of Fe, Cr, Ni, Zn as m1 were tested using ICP. A percentage of the magnetic impurities was m1/m0.

### 9. Test for Ash in Conductive Carbon Black:

Carbon powder with weight m0 (m0=2.0 g) was taken and burned at 800° C. for 5 h. Then, the weight of the remaining ash was weighed as m1. The content of ash was m1/m0.

### 10. Test for Loss Temperature of Volatile Component in Conductive Carbon Black:

2 g of carbon black was taken and baked at 60° C. for 30 min. Then, 0.1 to 0.2 g of the baked carbon black was taken and subjected to test using TG. The temperature was increased to 900° C. at a speed of 10° C./min. A temperature-weight curve was obtained. A temperature point where the weight began to lose was a loss temperature of a volatile component.

### 11. Test for Average Particle Size of Carbon Black Unit:

(1) A lithium-ion battery was disassembled to obtain a positive electrode plate; (2) the above positive electrode plate was soaked in DMC at room temperature for 30 min, then taken out and dried; (3) the positive electrode plate obtained in step (2) was taken, corroded with a concentrated sulfuric acid, and filtered to obtain a conductive agent. After drying, a particle size of primary particles of carbon black particles was tested under TEM, with a magnification of 80,000×. 50 particles were tested. An average of all test values was taken as a final result.

### EXAMPLES

The following examples more specifically describe the content disclosed in this application. These examples are only for illustrative purposes, as various modifications and changes within the scope of the disclosure of this application will be apparent to those skilled in the art. Unless otherwise stated, all parts, percentages, and ratios reported in the following examples are measured according to the weight, and all reagents used in the examples are commercially available or synthesized according to conventional methods and can be used directly without further treatment, and the instruments used in the examples are commercially available.

Some specific examples and comparative examples are listed below to better illustrate this application, where lithium-ion batteries were used as examples.

### Example 1-1

A raw material was placed in a reaction furnace and undergone a cracking reaction at a high temperature of 1000° C. to 1500° C. to generate carbon black particles. The carbon black particles were blown out from a furnace tube, cooled, and collected. The parameters of the conductive carbon black were shown in Table 1.

Positive electrode: Lithium cobalt oxide, a conductive agent, and polyvinylidene fluoride were mixed at a weight ratio of 97.7:1:1.3 and added to N-methylpyrrolidone, and then stirred into a uniform slurry. The slurry was stirred, applied, dried, rolled, and tab welded to obtain a battery positive electrode, where a mass ratio of conductive carbon black to carbon nanotubes in the conductive agent was 1.

Electrolyte: In an argon-filled glove box, ethylene carbonate, dimethyl carbonate, and methyl ethyl carbonate were mixed at a mass ratio of 3:4:3, 2,2-difluoroethyl acetate accounted for 2% of a total mass of an electrolyte, a dinitrile additive accounted for 1% of the total mass of the electrolyte, and propyl propionate accounted for 20% of the total mass of the electrolyte were added. A certain amount of lithium hexafluorophosphate was added such that a final mass percentage of lithium hexafluorophosphate in the total mass of the electrolyte was 9%.

Separator: A 5 μm thick polyethylene substrate (PE) was used for a separator. 2 m aluminum oxide ceramic layers were applied on both sides of the separator respectively; and finally, 2.5 mg/cm² of polyvinylidene fluoride (PVDF) was applied on both sides of the separator coated with the ceramic layers, and dried.

Negative electrode plate: Artificial graphite as a negative electrode active material, conductive carbon black as a conductive agent, styrene-butadiene rubber (SBR) as a binder, and sodium carboxymethyl cellulose (CMC) as a thickener were mixed at a weight ratio of 97:1:1:1, deionized water was added, and the resulting mixture was stirred well under the action of a vacuum mixer to obtain a negative electrode slurry, where a solid content of the negative electrode slurry was 80%. The negative electrode slurry was uniformly applied on one side surface of a negative electrode current collector copper foil, and dried at 110° C. to obtain a negative electrode plate with one surface coated with a negative electrode active material layer having a thickness of 90 μm. The above steps were repeated on the other side surface of the negative electrode current collector copper foil to obtain a negative electrode plate with both surfaces coated with negative electrode active material layers, followed by cold pressing, cutting, and slitting to obtain a negative electrode plate with specifications of 476 mm×93.5 mm. Surface resistance of the negative electrode plate was tested as 0.002 mΩ/cm².

Preparation of lithium-ion battery: The positive electrode plate, the separator, and the negative electrode plate were sequentially stacked, so that the separator was positioned between the positive electrode plate and the negative electrode plate to play a role of isolation. The resulting stack was wound to obtain an electrode assembly. After tab welding, the electrode assembly was placed in an outer packaging aluminum-plastic film, dehydrated at 80° C., and then injected with the above electrolyte, followed by processes such as vacuum packaging, standing, formation, shaping, and capacity, to obtain a lithium-ion battery.

### Examples 1-2 to 1-16 and Comparative Examples 1-1 and 1-2

The preparation of the lithium-ion battery was substantially the same as that in Example 1-1, with only differences in the M/N, the percentage M of the volatile component, the specific surface area N, the percentage A of oxygen element, the percentage B of hydrogen element, and A/B of the conductive carbon black, and the ratio of the peak value at 1700-1730 cm⁻¹ to the peak value at 2500-3000 cm⁻¹ in the infrared absorption spectrum of the conductive carbon black. The specific parameters were shown in Table 1.

The lithium-ion battery was subjected to test for is DCR@25° C. 20% SOC and test for cell thickness swelling rate after storage at 85° C. for 8 h. The results were shown in Table 1.

TABLE 1

| | | | | | | | Ratio of peak | | Cell |
|---|---|---|---|---|---|---|---|---|---|
| | | | | | | | value at 1700- | | thickness |
| | | | | | | | 1730 cm⁻¹ | | swelling |
| | | | | | | | to peak | 1 s | rate after |
| | | | | | | | value at | DCR@25° C. | storage at |
| | | M | N | A | B | | 2500-3000 | 20% SOC | 85° C. for |
| | M/N | (%) | (m²/g) | (%) | (%) | A/B | cm⁻¹ | (mΩ) | 8 h (%) |
| Example 1-1 | 0.003 | 0.1 | 33.3 | 0.03 | 0.03 | 1.0 | 0.4 | 75 | 3.5 |
| Example 1-2 | 0.004 | 0.2 | 50.0 | 0.06 | 0.06 | 1.0 | 0.4 | 63 | 8.0 |
| Example 1-3 | 0.005 | 0.3 | 60.0 | 0.09 | 0.09 | 1.0 | 0.4 | 58 | 5.0 |
| Example 1-4 | 0.010 | 0.5 | 50.0 | 0.15 | 0.15 | 1.0 | 0.4 | 55 | 6.0 |
| Example 1-5 | 0.015 | 0.6 | 40.0 | 0.18 | 0.18 | 1.0 | 0.4 | 60 | 7.0 |
| Example 1-6 | 0.02 | 0.6 | 30.0 | 0.18 | 0.18 | 1.0 | 0.4 | 80 | 5.0 |
| Example 1-7 | 0.0088 | 0.7 | 79.5 | 0.21 | 0.21 | 1.0 | 0.4 | 55 | 10.0 |
| Example 1-8 | 0.005 | 0.3 | 60.0 | 0.05 | 0.1 | 0.5 | 0.2 | 65 | 3.0 |
| Example 1-9 | 0.005 | 0.3 | 60.0 | 0.07 | 0.1 | 0.7 | 0.25 | 62 | 4.0 |
| Example 1-10 | 0.005 | 0.3 | 60.0 | 0.08 | 0.1 | 0.8 | 0.3 | 60 | 5.0 |
| Example 1-11 | 0.005 | 0.3 | 60.0 | 0.1 | 0.083 | 1.2 | 0.5 | 56 | 6.0 |
| Example 1-12 | 0.005 | 0.3 | 60.0 | 0.15 | 0.1 | 1.5 | 0.6 | 53 | 8.0 |
| Example 1-13 | 0.0088 | 0.7 | 79.5 | 0.3 | 0.15 | 2 | 0.7 | 63 | 12.0 |
| Example 1-14 | 0.0088 | 0.7 | 79.5 | 0.15 | 0.3 | 0.5 | 0.2 | 58 | 8.0 |
| Example 1-15 | 0.005 | 0.3 | 60.0 | 0.05 | 0.12 | 0.42 | 0.15 | 68 | 4.0 |
| Example 1-16 | 0.0088 | 0.7 | 79.5 | 0.3 | 0.12 | 2.5 | 0.8 | 55 | 12.0 |
| Comparative | 0.002 | 0.1 | 50.0 | 0.03 | 0.03 | 1.0 | 0.4 | 90 | 8.0 |
| Example 1-1 | | | | | | | | | |
| Comparative | 0.025 | 0.7 | 28.0 | 0.21 | 0.21 | 1.0 | 0.4 | 85 | 18.0 |
| Example 1-2 | | | | | | | | | |

According to Table 1, as compared with the comparative examples, in examples, when M/N is controlled within the range of this application, the is DCR@25° C. 20% SOC and the cell thickness swelling rate after storage at 85° C. for 8 h of the lithium-ion batteries are significantly improved. When the conductive carbon black of this application is used and the cell thickness swelling rate after storage at 85° C. for 8 h of the conductive carbon black satisfies the range of this application, the two synergistically act, and the lithium-ion batteries have good stability and low DC internal resistance.

According to Examples 1-1 to 1-7 and Comparative Examples 1-1 and 1-2, when the conductive carbon black satisfies one of 0.003≤M/N≤0.02, 0.1≤M≤0.7, or 30≤N≤80, the lithium-ion batteries have better stability and lower DC internal resistance.

On this basis, according to Examples 1-3 to 1-5, it can be seen that when the conductive carbon black satisfies 0.005≤M/N≤0.01 and/or 0.3≤M≤0.6, the lithium-ion batteries have better high-temperature stability and lower DC internal resistance.

According to Examples 1-8 to 1-14, when the conductive carbon black satisfies one of the following: 0.5≤A/B≤2, 0.05≤A≤0.3, and the ratio of the peak value at 1700-1730 cm⁻¹ to the peak value at 2500-3000 cm¹ in the infrared absorption spectrum of the conductive carbon black is 0.2 to 0.7, the lithium-ion batteries have better stability and lower DC internal resistance.

On this basis, according to Examples 1-8 to 1-14, when the conductive carbon black satisfies one of the following: 0.8≤A/B≤1.5, 0.08≤A≤0.15, and the ratio of the peak value at 1700-1730 cm⁻¹ to the peak value at 2500-3000 cm⁻¹ in the infrared absorption spectrum of the conductive carbon black is 0.3 to 0.6, the lithium-ion batteries have better stability and lower DC internal resistance.

### Examples 2-1 to 2-14

The preparation of the lithium-ion battery was substantially the same as that in Example 1-1, with only differences in the content of magnetic impurities, the content of ash, the initial loss temperature of the volatile component, and the full width at half maximum of the (002) crystal plane diffraction peak in the X-ray diffraction pattern of the conductive carbon black. The specific parameters were shown in Table 2.

The lithium-ion battery was subjected to test for the cycling capacity retention rate after 500 cycles at 45° C. The results were shown in Table 2.

TABLE 2

| | | | | Full width at | | Cycling |
|---|---|---|---|---|---|---|
| | | | | half maximum | | capacity |
| | | | | of (002) crystal | | retention |
| | | | Initial loss | plane | Powder | rate after |
| | | | temperature | diffraction peak | resistivity | 500 |
| | Magnetic | | of volatile | in X-ray | of carbon | cycles |
| | impurities | Ash | component | diffraction | black | at 45° C. |
| | (ppb) | (ppb) | (° C.) | pattern | (mΩ) | (%) |
| Example 1-1 | 250 | 200 | 680 | 3° | 38 | 85% |
| Example 2-1 | 100 | 50 | 680 | 3° | 42 | 88% |
| Example 2-2 | 350 | 320 | 680 | 3° | 37 | 83% |
| Example 2-3 | 500 | 500 | 680 | 3° | 35 | 80% |
| Example 2-4 | 250 | 200 | 550 | 3° | 38 | 84% |
| Example 2-5 | 250 | 200 | 800 | 3° | 38 | 86% |
| Example 2-6 | 250 | 200 | 950 | 3° | 38 | 83% |
| Example 2-7 | 250 | 200 | 680 | 1° | 30 | 84% |
| Example 2-8 | 250 | 200 | 680 | 1.5° | 33 | 86% |
| Example 2-9 | 250 | 200 | 680 | 5° | 48 | 83% |
| Example 2-10 | 550 | 550 | 680 | 3° | 35 | 78% |
| Example 2-11 | 250 | 200 | 500 | 3° | 38 | 82% |
| Example 2-12 | 250 | 200 | 1000 | 3° | 38 | 81% |
| Example 2-13 | 250 | 200 | 680 | 0.5 | 28 | 82% |
| Example 2-14 | 250 | 200 | 680 | 5.5 | 53 | 81% |

According to Table 2, when the content of the magnetic impurities, the content of ash, the initial loss temperature of the volatile component, and the full width at half maximum of the (002) crystal plane diffraction peak in the X-ray diffraction pattern of the conductive carbon black are controlled within the ranges of this application, the lithium-ion batteries have good high-temperature cycling performance and charging and discharging performance.

According to Example 1-1, Examples 2-1 to 2-3, and Example 2-10, when the conductive carbon black includes 100 ppb to 500 ppb of magnetic impurities and/or 50 ppb to 500 ppb of ash, the lithium-ion batteries have better high-temperature cycling performance.

According to Example 1-1, Examples 2-4 to 2-6, and Examples 2-11 and 2-12, when the loss temperature of the volatile component in the conductive carbon black is 550° C. to 950° C., the lithium-ion batteries have better high-temperature cycling performance.

According to Example 1-1, Examples 2-7 to 2-9, and Examples 2-13 and 2-14, when the full width at half maximum of the (002) crystal plane diffraction peak in the X-ray diffraction pattern of the conductive carbon black is 10 to 5°, the lithium-ion batteries have better high-temperature cycling performance.

According to Example 1-1 and Example 2-8, when the full width at half maximum of the (002) crystal plane diffraction peak in the X-ray diffraction pattern of the conductive carbon black is 1.5° to 3°, the lithium-ion batteries have better high-temperature cycling performance.

### Examples 3-1 to 3-29

The preparation of the lithium-ion battery was substantially the same as that in Example 1-1, with only differences in W₂/(E×W₁), E, W₁, W₂, C, D, and C/D. The specific parameters were shown in Table 3.

The lithium-ion battery was subjected to test for discharge rate at 3.5 C and test for cell thickness swelling rate after storage at 85° C. for 8 h. The results were shown in Table 3.

TABLE 3

| | | | | | Mass | | | | | Cell |
|---|---|---|---|---|---|---|---|---|---|---|
| | | | | | ratio of | | | | | thickness |
| | | | | | conductive | | | | Discharge | swelling rate |
| | W₂/ | | | | carbon black | | | | rate at | after storage |
| | (E × | E | W₁ | W₂ | to carbon | C | D | | 3.5 C | at 85° C. for |
| | W₁) | (m²/g) | (%) | (%) | nanotubes | (nm) | (nm) | C/D | (%) | 8 h (%) |
| Example 1-1 | 0.0087 | 150 | 1 | 1.3 | 1.0 | 3000 | 50 | 60.0 | 79 | 3.5 |
| Example 3-1 | 0.0040 | 40 | 3 | 0.48 | 1.0 | 3000 | 50 | 60.0 | 75 | 15.0 |
| Example 3-2 | 0.0057 | 70 | 2 | 0.8 | 1.0 | 3000 | 50 | 60.0 | 76 | 12.0 |
| Example 3-3 | 0.0070 | 100 | 1.72 | 1.2 | 1.0 | 3000 | 50 | 60.0 | 77 | 9.0 |
| Example 3-4 | 0.0081 | 200 | 0.8 | 1.3 | 1.0 | 3000 | 50 | 60.0 | 80 | 4.0 |
| Example 3-5 | 0.0074 | 250 | 0.7 | 1.3 | 1.0 | 3000 | 50 | 60.0 | 81 | 6.0 |
| Example 3-6 | 0.0120 | 200 | 0.8 | 1.92 | 1.0 | 3000 | 50 | 60.0 | 77 | 3.0 |
| Example 3-7 | 0.0133 | 250 | 0.6 | 2 | 1.0 | 3000 | 50 | 60.0 | 75 | 2.5 |
| Example 3-8 | 0.0140 | 300 | 0.5 | 2.1 | 1.0 | 3000 | 50 | 60.0 | 72 | 2.0 |
| Example 3-9 | 0.0087 | 150 | 1 | 1.3 | 0.6 | 3000 | 50 | 60.0 | 73 | 3.0 |
| Example 3-10 | 0.0087 | 150 | 1 | 1.3 | 0.7 | 3000 | 50 | 60.0 | 75 | 4.0 |
| Example 3-11 | 0.0087 | 150 | 1 | 1.3 | 0.8 | 3000 | 50 | 60.0 | 78 | 3.0 |
| Example 3-12 | 0.0087 | 150 | 1 | 1.3 | 1.5 | 3000 | 50 | 60.0 | 76 | 5.0 |
| Example 3-13 | 0.0087 | 150 | 1 | 1.3 | 1.8 | 3000 | 50 | 60.0 | 72 | 8.0 |
| Example 3-14 | 0.0087 | 150 | 1 | 1.3 | 2.0 | 3000 | 50 | 60.0 | 70 | 10.0 |
| Example 3-15 | 0.0087 | 150 | 1 | 1.3 | 1.0 | 1000 | 30 | 33.3 | 74 | 8.0 |
| Example 3-16 | 0.0087 | 150 | 1 | 1.3 | 1.0 | 1500 | 40 | 37.5 | 75 | 6.0 |
| Example 3-17 | 0.0087 | 150 | 1 | 1.3 | 1.0 | 1500 | 60 | 25.0 | 72 | 3.0 |
| Example 3-18 | 0.0087 | 150 | 1 | 1.3 | 1.0 | 3000 | 40 | 75.0 | 82 | 5.0 |
| Example 3-19 | 0.0087 | 150 | 1 | 1.3 | 1.0 | 5000 | 60 | 83.3 | 78 | 3.5 |
| Example 3-20 | 0.0087 | 150 | 1 | 1.3 | 1.0 | 6000 | 70 | 85.7 | 76 | 3.0 |
| Example 3-21 | 0.0087 | 150 | 1 | 1.3 | 1.0 | 6000 | 40 | 150.0 | 73 | 5.0 |
| Example 3-22 | 0.003 | 30 | 3 | 0.27 | 1.0 | 3000 | 50 | 60.0 | 72 | 20.0 |
| Example 3-23 | 0.016 | 350 | 0.4 | 2.24 | 1.0 | 3000 | 50 | 60.0 | 70 | 1.5 |
| Example 3-24 | 0.0087 | 150 | 1 | 1.3 | 0.5 | 3000 | 50 | 60.0 | 70 | 2.0 |
| Example 3-25 | 0.0087 | 150 | 1 | 1.3 | 2.2 | 3000 | 50 | 60.0 | 68 | 14.0 |
| Example 3-26 | 0.0087 | 150 | 1 | 1.3 | 1.0 | 1500 | 20 | 75.0 | 72 | 12.0 |
| Example 3-27 | 0.0087 | 150 | 1 | 1.3 | 1.0 | 8500 | 80 | 106.3 | 67 | 10.0 |
| Example 3-28 | 0.0087 | 150 | 1 | 1.3 | 1.0 | 1500 | 80 | 18.8 | 68 | 2.0 |
| Example 3-29 | 0.0087 | 150 | 1 | 1.3 | 1.0 | 3000 | 15 | 200.0 | 66 | 10.0 |

According to Table 3, when W₂/(E×W₁), E, W₁, W₂, C, D, and C/D are controlled within the ranges of this application, the lithium-ion batteries have good high-temperature stability and charging and discharging performance.

According to Example 1-1, Examples 3-1 to 3-8, and Examples 3-22 and 3-23, when the positive electrode plate satisfies 0.004×E×W₁≤W₂≤0.014×E×W₁ and/or 40≤E≤300, the lithium-ion batteries have better high-temperature stability and charging and discharging performance.

On this basis, according to Example 1-1 and Examples 3-3 to 3-6, when the positive electrode plate satisfies 0.007×E×W₁≤W₂≤0.012×E×W₁ and/or 100≤E≤200, the lithium-ion batteries have better high-temperature stability and charging and discharging performance.

According to Example 1-1, Examples 3-9 to 3-14, and Examples 3-24 and 3-25, when the mass ratio of the conductive carbon black to the carbon nanotubes in the conductive agent is 0.6 to 2, the lithium-ion batteries have better high-temperature stability and charging and discharging performance.

On this basis, according to Example 1-1 and Examples 3-11 and 3-12, when the mass ratio of the conductive carbon black to the carbon nanotubes in the conductive agent is 0.8 to 1.5, the lithium-ion batteries have better high-temperature stability and charging and discharging performance.

According to Example 1-1, Examples 3-15 to 3-21, and Examples 3-26 to 3-29, when the conductive carbon black satisfies at least one of 25≤C/D≤150, 1000≤C≤6000, or 30≤D≤70, the lithium-ion batteries have better high-temperature stability and charging and discharging performance.

On this basis, according to Example 1-1 and Examples 3-16 to 3-19, when the conductive carbon black satisfies at least one of 25≤C/D≤150, 1500≤C≤5000, or 40≤D≤60, the lithium-ion batteries have better high-temperature stability and charging and discharging performance.

### Examples 4-1 to 4-20

The preparation of the lithium-ion battery was substantially the same as that in Example 1-1, with only differences in E/Z, the percentage of 2,2-difluoroethyl acetate in the electrolyte, G, X, and G/X. The specific parameters were shown in Table 4.

The lithium-ion battery was subjected to test for the cycling capacity retention rate after 500 cycles at 45° C. and test for the discharge rate at 3.5 C. The results were shown in Table 4.

TABLE 4

| | | | | Percentage | | | | Cycling | |
|---|---|---|---|---|---|---|---|---|---|
| | | | | of | | | | capacity | Discharge |
| | | | | 2,2- | | | | retention rate | rate at |
| | E | Z | | difluoroethyl | G | X | | after 500 cycles | 3.5 C |
| | (m²/g) | (%) | E/Z | acetate (%) | (μm) | (%) | G/X | at 45° C. (%) | (%) |
| Example 1-1 | 150 | 1 | 150 | 2 | 15 | 15 | 1.0 | 85% | 79% |
| Example 4-1 | 40 | 0.04 | 1000 | 2 | 15 | 15 | 1.0 | 80% | 72% |
| Example 4-2 | 150 | 0.5 | 300 | 2 | 15 | 15 | 1.0 | 83% | 81% |
| Example 4-3 | 150 | 2 | 75 | 2 | 15 | 15 | 1.0 | 86% | 77% |
| Example 4-4 | 150 | 3 | 50 | 2 | 15 | 15 | 1.0 | 84% | 74% |
| Example 4-5 | 300 | 3 | 100 | 2 | 15 | 15 | 1.0 | 85% | 76% |
| Example 4-6 | 150 | 1 | 150 | 0.5 | 15 | 15 | 1.0 | 81% | 75% |
| Example 4-7 | 150 | 1 | 150 | 1 | 15 | 15 | 1.0 | 83% | 80% |
| Example 4-8 | 150 | 1 | 150 | 3 | 15 | 15 | 1.0 | 86% | 77% |
| Example 4-9 | 150 | 1 | 150 | 5 | 15 | 15 | 1.0 | 83% | 74% |
| Example 4-10 | 150 | 1 | 150 | 2 | 5 | 30 | 0.2 | 81% | 78% |
| Example 4-11 | 150 | 1 | 150 | 2 | 10 | 15 | 0.7 | 82% | 81% |
| Example 4-12 | 150 | 1 | 150 | 2 | 15 | 7.5 | 2.0 | 83% | 80% |
| Example 4-13 | 150 | 1 | 150 | 2 | 15 | 30 | 0.5 | 84% | 77% |
| Example 4-14 | 150 | 1 | 150 | 2 | 20 | 15 | 1.3 | 86% | 76% |
| Example 4-15 | 150 | 1 | 150 | 2 | 25 | 5 | 5.0 | 83% | 73% |
| Example 4-16 | 40 | 2 | 20 | 2 | 15 | 15 | 1.0 | 78% | 69% |
| Example 4-17 | 300 | 0.2 | 1500 | 2 | 15 | 15 | 1.0 | 77% | 72% |
| Example 4-18 | 150 | 1 | 150 | 2 | 5 | 50 | 0.1 | 75% | 73% |
| Example 4-19 | 150 | 1 | 150 | 2 | 25 | 3 | 8.3 | 84% | 67% |
| Example 4-20 | 150 | 1 | 150 | 7 | 15 | 15 | 1.0 | 78% | 70% |

According to Table 4, when E/Z, G, and G/X are controlled within the ranges of this application, the lithium-ion batteries have good high-temperature cycling performance and charging and discharging performance.

According to Example 1-1, Examples 4-1 to 4-5, and Examples 4-16 and 4-17, when the electrochemical apparatus satisfies 50≤E/Z≤1000, the lithium-ion batteries have better high-temperature cycling performance and charging and discharging performance.

According to Example 1-1, Examples 4-6 to 4-9, and Example 4-20, when the electrolyte includes 0.5% to 5% of 2,2-difluoroethyl acetate, the lithium-ion batteries have better high-temperature cycling performance and charging and discharging performance.

According to Example 1-1, Examples 4-10 to 4-15, and Examples 4-18 and 4-19, when the electrochemical apparatus satisfies any one of 5≤G≤25, 5≤X≤30, or 2≤G/X≤5, the lithium-ion batteries have better high-temperature cycling performance and charging and discharging performance.

Although this application has been described with reference to preferred embodiments, various improvements can be made thereto and components therein can be replaced with equivalents without departing from the scope of this application. In particular, as long as there is no structural conflict, the technical features mentioned in the various embodiments can be combined in any manner. This application is not limited to the specific embodiments disclosed herein, but includes all technical solutions falling within the scope of the claims.

What is claimed is:

1. A conductive carbon black, wherein the conductive carbon black comprises a plurality of carbon black units and pores located between adjacent carbon black units; and
based on a total mass of the conductive carbon black, a mass percentage of a volatile component in the conductive carbon black is M %, a specific surface area of the conductive carbon black is N m²/g, and 0.003≤M/N≤0.02.

2. The conductive carbon black according to claim 1, wherein 0.005≤M/N≤0.01.

3. The conductive carbon black according to claim 1, wherein based on the total mass of the conductive carbon black, the mass percentage of the volatile component in the conductive carbon black is 0.1% to 0.7%, and/or the specific surface area of the conductive carbon black is 30 m²/g to 80 m²/g.

4. The conductive carbon black according to claim 3, wherein based on the total mass of the conductive carbon black, the mass percentage of the volatile component in the conductive carbon black is 0.3% to 0.6%, and/or the specific surface area of the conductive carbon black is 50 m²/g to 60 m²/g.

5. The conductive carbon black according to claim 1, wherein based on the total mass of the conductive carbon black, the conductive carbon black comprises A % of oxygen element, the conductive carbon black comprises B % of hydrogen element, and 0.5≤A/B≤2.

6. The conductive carbon black according to claim 5, wherein 0.8≤A/B≤1.5.

7. The conductive carbon black according to claim 1, wherein based on the total mass of the conductive carbon black, the conductive carbon black comprises 0.05% to 0.3% of oxygen element, and/or the conductive carbon black comprises 0.05% to 0.3% of hydrogen element.

8. The conductive carbon black according to claim 7, wherein based on the total mass of the conductive carbon black, the conductive carbon black comprises 0.08% to 0.15% of oxygen element, and/or the conductive carbon black comprises 0.08% to 0.15% of hydrogen element.

9. The conductive carbon black according to claim 1, wherein the conductive carbon black satisfies at least one of the following:
(1) based on the total mass of the conductive carbon black, the conductive carbon black comprises 100 ppb to 500 ppb of magnetic impurities;
(2) based on the total mass of the conductive carbon black, the conductive carbon black comprises 50 ppb to 500 ppb of ash;
(3) a loss temperature of the volatile component in the conductive carbon black is 550° C. to 950° C.;
(4) Dᵥ50 of the conductive carbon black is 1000 nm to 6000 nm;
(5) an average particle size of the carbon black units is 30 nm to 70 nm;
(6) a powder resistivity of the conductive carbon black is 25 mΩ·cm to 45 mΩ·cm;
(7) a full width at half maximum of a (002) crystal plane diffraction peak in an X-ray diffraction pattern of the conductive carbon black is 1° to 5°;
(8) a ratio of a peak value at 1700-1730 cm⁻¹ to a peak value at 2500-3000 cm⁻¹ in an infrared absorption spectrum of the conductive carbon black is 0.2 to 0.7;
(9) the conductive carbon black comprises a core formed by stacking the plurality of carbon black units and a plurality of branches connected to the core; or
(10) the Dᵥ50 of the conductive carbon black is C nm, an average particle size of the carbon black units is D nm, and the conductive carbon black satisfies: 25≤C/D≤150.

10. The conductive carbon black according to claim 9, wherein the conductive carbon black satisfies at least one of the following:
(1) the Dᵥ50 of the conductive carbon black is 1500 nm to 5000 nm;
(2) the average particle size of the carbon black units is 40 nm to 60 nm;
(3) the powder resistivity of the conductive carbon black is 30 mΩ·cm to 40 mΩ·cm;
(4) the full width at half maximum of the (002) crystal plane diffraction peak in the X-ray diffraction pattern of the conductive carbon black is 1.5° to 3°; or
(5) the ratio of the peak value at 1700-1730 cm⁻¹ to the peak value at 2500-3000 cm⁻¹ in the infrared absorption spectrum of the conductive carbon black is 0.3 to 0.6.

11. A positive electrode plate, comprising a binder, positive electrode active material particles, and a conductive agent; wherein the conductive agent comprises a conductive carbon black, wherein the conductive carbon black comprises a plurality of carbon black units and pores located between adjacent carbon black units; and
based on a total mass of the conductive carbon black, a mass percentage of a volatile component in the conductive carbon black is M %, a specific surface area of the conductive carbon black is N m²/g, and 0.003≤M/N≤0.02.

12. The positive electrode plate according to claim 11, wherein the positive electrode plate satisfies at least one of the following:
(1) a specific surface area of the conductive agent is E m²/g, based on a total mass of the positive electrode plate, the positive electrode plate comprises W₁% of the conductive agent and W₂% of the binder, and the positive electrode plate satisfies: 0.004×E×W₁≤W₂≤0.014×E×W₁;
(2) a specific surface area of the conductive agent is 40 m²/g to 300 m²/g;
(3) based on a total mass of the positive electrode plate, the positive electrode plate comprises 0.5% to 3% of the conductive agent;
(4) based on a total mass of the positive electrode plate, the positive electrode plate comprises 0.5% to 5% of the binder; or
(5) a mass ratio of the conductive carbon black to the carbon nanotubes in the conductive agent is 0.6 to 2.

13. The positive electrode plate according to claim 12, wherein the positive electrode plate satisfies at least one of the following:
(1) the positive electrode plate satisfies: 0.007×E×W₁≤W₂≤0.012×E×W₁;
(2) the specific surface area of the conductive agent is 100 m²/g to 200 m²/g;
(3) based on the total mass of the positive electrode plate, the positive electrode plate comprises 0.8% to 2.5% of the conductive agent;
(4) based on the total mass of the positive electrode plate, the positive electrode plate comprises 1.0% to 3.0% of the binder; or
(5) the mass ratio of the conductive carbon black to the carbon nanotubes in the conductive agent is 0.8 to 1.5.

14. An electrochemical apparatus, comprising a positive electrode plate, a negative electrode plate, a separator, and an electrolyte; wherein the positive electrode plate comprises a binder, positive electrode active material particles, and a conductive agent, wherein the conductive agent comprises a conductive carbon black, wherein the conductive carbon black comprises a plurality of carbon black units and pores located between adjacent carbon black units; and
based on a total mass of the conductive carbon black, a mass percentage of a volatile component in the conductive carbon black is M %, a specific surface area of the conductive carbon black is N m²/g, and 0.003≤M/N≤0.02.

15. The electrochemical apparatus according to claim 14, wherein the electrochemical apparatus satisfies at least one of the following:
(1) based on a total mass of the electrolyte, the electrolyte comprises Z % of a dinitrile additive, a specific surface area of the conductive agent is E m²/g, and the electrochemical apparatus satisfies: 50≤E/Z≤1000;
(2) based on a total mass of the electrolyte, the electrolyte comprises 0.5% to 5% of 2,2-difluoroethyl acetate;
(3) Dᵥ50 of positive electrode active material particles is G m, based on a total mass of the electrolyte, the electrolyte comprises X % of propyl propionate, and the electrochemical apparatus satisfies: 2≤G/X≤5;
(4) the Dᵥ50 of the positive electrode active material particles is 5 μm to 25 μm; or
(5) based on a total mass of the electrolyte, the electrolyte comprises 5% to 30% of propyl propionate.

16. The electrochemical apparatus according to claim 14, wherein the positive electrode plate satisfies at least one of the following:
(1) a specific surface area of the conductive agent is E m²/g, based on a total mass of the positive electrode plate, the positive electrode plate comprises W₁% of the conductive agent and W₂% of the binder, and the positive electrode plate satisfies: 0.004×E×W₁≤W₂≤0.014×E×W₁;
(2) a specific surface area of the conductive agent is 40 m²/g to 300 m²/g;
(3) based on a total mass of the positive electrode plate, the positive electrode plate comprises 0.5% to 3% of the conductive agent;
(4) based on a total mass of the positive electrode plate, the positive electrode plate comprises 0.5% to 5% of the binder; or
(5) a mass ratio of the conductive carbon black to the carbon nanotubes in the conductive agent is 0.6 to 2.

17. The electrochemical apparatus according to claim 14, wherein the positive electrode plate satisfies at least one of the following:
(1) the positive electrode plate satisfies: 0.007×E×W₁≤W₂≤0.012×E×W₁;
(2) the specific surface area of the conductive agent is 100 m²/g to 200 m²/g;
(3) based on the total mass of the positive electrode plate, the positive electrode plate comprises 0.8% to 2.5% of the conductive agent;
(4) based on the total mass of the positive electrode plate, the positive electrode plate comprises 1.0% to 3.0% of the binder; or
(5) the mass ratio of the conductive carbon black to the carbon nanotubes in the conductive agent is 0.8 to 1.5.

18. The electrochemical apparatus according to claim 14, wherein 0.005≤M/N≤0.01.

19. The electrochemical apparatus according to claim 14, wherein based on the total mass of the conductive carbon black, the mass percentage of the volatile component in the conductive carbon black is 0.1% to 0.7%, and/or the specific surface area of the conductive carbon black is 30 m²/g to 80 m²/g.

20. An electronic apparatus, comprising the electrochemical apparatus according to claim 14.
